(19) United States
(12) Patent Application Publication
(10) Pub. No.: US 2006/0140487 A1
(43) Pub. Date: Jun. 29, 2006

(54) Image compressing apparatus and image decoding apparatus and image converting apparatus and image processing method

(75) Inventors: Sunao Tabata, Mishima-shi (JP); Hiroki Kanno, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/019,986

(22) Filed: Dec. 23, 2004

(51) Int. Cl. G06K 9/36

(52) U.S. Cl. 382/232

(57) ABSTRACT

An image compression apparatus includes a block division unit that executes block division of an image, a first compression unit that compresses the image, which is divided by the block division unit, to first compression data, a second compression unit that compresses the image, which is divided by the block division unit, to second compression data on the basis of an amount of the first compression data and a predetermined data amount per block, and a code conversion unit that executes conversion to third compression data that is formed of the first compression data and the second compression data and has a predetermined code amount per block. A plurality of encoding schemes can be selected at the same time for the same region of the image, thereby improving the convenience in use of codes and the image quality.

### BACKGROUND OF THE INVENTION

1. Field of the Invention

The present invention relates to an image compression apparatus that encodes and compresses an image, an image decoding apparatus that decodes a compressed image, an image converting apparatus and an image processing method.

2. Description of the Related Art

In the prior art, in order to obtain both a good image quality and a good compression ratio in image compression, some determination signals are used to switch (internal generation, external input) compression parameters and a plurality of compression processes, and the image is corrected at a time of decoding.

As regards this kind of technique, Jpn. Pat. Appln. KOKAI Publication No. 2001-186356 (Document 1), for instance, discloses that a region is separated into a character, a figure, a photo, etc. using a region separation technique. Based on attributes, compression parameters of JPEG (Joint Photographic Experts Group) are altered, and compression schemes, such as JPEG and LZ (Lempel-Zip), are switched. Thus, image region information is compressed by JBIG (Joint Bilevel Image Group) scheme, and the image quality and compression ratio are improved.

Jpn. Pat. Appln. KOKAI Publication No. 2001-43363 (Document 2) discloses a technique of examining whether adjacent pixels are the same in units of a block, and determining whether the pixel is a character or a picture. If the pixel is a character, the pixel is subjected to reversible JPEG (predictive coding). If the pixel is a picture, the pixel is subjected to irreversible JPEG (DCT). Thus, the image quality and compression ratio are improved.

Jpn. Pat. Appln. KOKAI Publication No. 5-294018 (Document 3) discloses that a character region is detected prior to compression. Compression is executed regardless of the detection result. After decoding, the detection result is used to correct the image quality of the character part. Thus, the image quality is improved.

In addition, “Efficient Coding Scheme based on the three mode MMR for Text Parts of Images with Texts and Photographs”, Watanabe, et al., PCSJ95, pp. 83-84 (1995) (Document 4), discloses a technique that is specifically applied to a text image, which cannot easily be processed by JPEG scheme. In an image with a text and a photograph, the text region is treated with 3-value information, and not with simple binary information, and is compressed. Thus, the image quality is improved.

In addition, the following standardization techniques are disclosed in connection with image compression.

ISO/IEC16485 (MRC) (Document 5) is a standard wherein a plurality of compression formats are applied to divided regions of an image, although only one coding format, such as JPEG or JBIG, is conventionally applicable to one image. This is a standardization technique called MRC (Mixed Raster Content). An image is divided into a plurality of layers (Foreground, Mask, Background) and suitable image formats (multi-value, binary-value, multi-value continuous tone, resolution) and compression schemes (MMR, JPEG, etc.) can be chosen.

ISO/IEC15444 (JPEG2000) (Document 6) is a compression standardization technique that is called JPEG2000, and discloses an ROI (Region of Interest) technique. In the ROI technique, the degree at which data is left is varied between a designated region and the other region. A greater amount of data (high image quality) is left in the designated region that is of greater importance than the other region. Thereby, the total amount of coded data is reduced.

The following techniques have been disclosed as prior-art inventions for the inventor of the present invention.

Jpn. Pat. Appln. KOKAI Publication No. 11-69164 (Document 7) discloses a structure wherein a color image is converted to luminance and chrominance. The luminance information is subjected to fixed-length coding, by changing the resolution and the number of gray levels in accordance with a character region and a photo region, and the resultant data is stored in a memory. When the data is to be stored in an HDD, etc., the data is subjected to variable-length coding.

Jpn. Pat. Appln. KOKAI Publication No. 2004-194266 (Document 8) discloses a structure wherein an image is subjected to fixed-length coding and the resultant image data is stored in a memory. When the data is to be stored in an HDD, etc., the encoded data is converted to another variable-length code during a decoding process. Thereby, the fixed-length coding and variable-length coding are realized with the same compression technique.

U.S. patent application Ser. No. 10/806,454 (Document 9) discloses a technique wherein the data amount at a time of variable-length coding is efficiently reduced or the accessibility to image attributes, such as color image attributes or monochromatic attributes, is improved in order to realize easy external use of data that has been fixed-length-encoded within an MFP.

In another possible scheme, both a discrimination signal and an image signal may be variable-length-compressed, and a combination of both may be fixed-length-encoded.

In the schemes of Documents 1 and 2, however, the image is definitely separated and the scheme is switched. For example, in the case where a character is laid over a photo, the character may be black and the photo may be color. In this case, it is difficult to determine which coding scheme is to be used. Moreover, since the code amount may vary, there is the problem that the handling is difficult. Besides, there is no detailed description of the method of use of codes.

The technique of Document 3 requires an additional code of detection information, and it is uncertain whether adequate image quality can be obtained by correction.

In the scheme of Document 4, the character is treated as 3-value information. Thereby, the image quality of text is improved. However, only a character image that is extracted from a mixed image is treated. Document 4 is silent on the method of treating a mixed image including a photo.

The layer structure that is specified in Document 5 is that of the decoding side. It appears that the problem of Document 1 can be avoided by encoding a difficult-to-separate region with a plurality of layers at the time of encoding. However, overlapping data is produced and data needs to be treated with a large category, i.e. a category of a layer. Thus, the handling in Document 5 is difficult.

In Document 6, when an irreversible process is applied, a greater amount of codes (information) can be assigned to the designated region than to the other region. However, the coding scheme is the same. If the technique of Document 6 is applied to regions of different signal characteristics, such as a character region and a photo region, the image quality and the amount of codes are not improved, compared to the case where the scheme is effectively switched.

In Document 7, the handling of codes is easy since fixed-length coding is executed. However, the parameters are altered with the same compression scheme. Like Document 1, the switching is effected in compression units. Thus, the same problem as in Document 1 remains.

Documents 8 and 9 disclose the structure wherein the fixed-length coding/variable-length coding is switched in the system. However, Documents 8 and 9 are silent on the switching of the compression scheme.

In the above-mentioned another possible scheme, the handling of data is easy since a plurality of encoded results are subjected to fixed-length coding. However, since the object signals are the discrimination signal and image signal, degradation in image tends to easily occur when an image with different characteristics of a character and a photo is to be compressed.

### BRIEF SUMMARY OF THE INVENTION

The object of an aspect of the present invention is to provide an image compression apparatus, an image decoding apparatus, an image converting apparatus and an image processing method, which can efficiently encoding a mixed image with different characteristics, and can make handling of codes easier.

According to an aspect of the present invention, there is provided an image compression apparatus comprising: a block division unit that executes block division of an image; a first compression unit that compresses the image, which is divided by the block division unit, to first compression data; a second compression unit that compresses the image, which is divided by the block division unit, to second compression data on the basis of an amount of the first compression data and a predetermined data amount per block; and a code conversion unit that executes conversion to third compression data that is formed of the first compression data and the second compression data and has a predetermined code amount per block.

According to another aspect of the present invention, there is provided an image processing method that executes such a process that as regards compression data that is produced by fixed-length compressing a block-divided image by at least one of first and second compression schemes, significant information in each compression unit of arbitrary compression data is replaced with other compression data that is compressed by at least one of the first and second compression schemes.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that schematically shows the structure of a color image output apparatus according to a first embodiment;

FIG. 2 is a view for explaining a JPEG compression scheme;

FIG. 3 is a view for explaining a JPEG decoding scheme;

FIG. 4 shows the structure of a compression unit;

FIG. 5 shows the structure of a JPEG entropy encoding unit;

FIG. 6A shows the structure of an entropy encoding unit in the first embodiment;

FIG. 6B shows the structure of the entropy encoding unit in the first embodiment;

FIG. 7 is a flow chart that illustrates the operation of a code-length determination unit in the first embodiment;

FIG. 8 shows the structure of a reversible compression unit in the first embodiment;

FIG. 9 is a view for explaining the operation of the reversible compression unit in the first embodiment;

FIG. 10A is a view for explaining the general operations of the reversible compression unit and irreversible compression unit in the first embodiment;

FIG. 10B is a view for explaining the general operations of the reversible compression unit and irreversible compression unit in the first embodiment;

FIG. 11A shows an example of finally generated codes in the first embodiment;

FIG. 11B shows an example of finally generated codes in the first embodiment;

FIG. 12 shows the structure of a decoding unit in the first embodiment;

FIG. 13 shows the structure of a third code conversion unit in the first embodiment;

FIG. 14 shows an example of an input image for illustrating the first embodiment;

FIG. 15 shows examples of code structures in cases where there is coincidence in shape between planes and there is no coincidence in shape between planes in the first embodiment;

FIG. 16 shows a structure of a reversible encoding unit according to a first modification of the first embodiment;

FIG. 17 shows another structure of the reversible encoding unit according to the first modification;

FIG. 18 is a block diagram that shows the structure of a second modification of the first embodiment;

FIG. 19 shows the structure of a compression unit according to a third modification of the first embodiment;

FIG. 20 shows the structure of a white/non-white determination unit according to the third embodiment;

FIG. 21 shows the structure of a reversible compression unit according to the third embodiment;

FIG. 22 is a view for explaining the operation of the white/non-white determination unit according to the third embodiment;

FIG. 23 is a view for explaining the operation of a white region embedding unit according to the third embodiment;

FIG. 24 is a view for explaining the operation of the reversible compression unit according to the third embodiment;

FIG. 25 is a view for explaining the operation of a decoding unit according to the third modification;

FIG. 26 is a view for explaining another example of the operation of the white/non-white process in the third embodiment;

FIG. 27A is a view for explaining the operation of a fourth modification;

FIG. 27B is a view for explaining the operation of the fourth modification;

FIG. 27C is a view for explaining the operation of the fourth modification;

FIG. 27D is a view for explaining the operation of the fourth modification;

FIG. 28 is a block diagram that schematically shows the structure of a color image output apparatus according to a second embodiment;

FIG. 29 shows the structure of a compression unit in the second embodiment;

FIG. 30 shows the structure of a reversible compression unit in the second embodiment;

FIG. 31A is a view for explaining the operation of the reversible compression unit in the second embodiment;

FIG. 31B is a view for explaining the operation of the reversible compression unit in the second embodiment; and

FIG. 32 is a view for explaining another example of the operation of the reversible compression unit in the second embodiment.

### DETAILED DESCRIPTION OF THE INVENTION

Embodiments of the present invention will now be described with reference to the accompanying drawings.

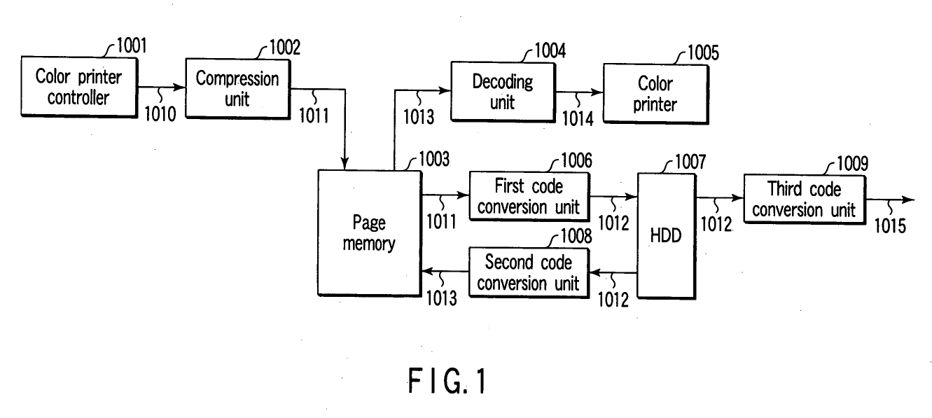

FIG. 1 schematically shows the structure of a color image output apparatus according to a first embodiment of the invention. The color image output apparatus comprises a color printer controller 1001, a compression unit 1002, a page memory 1003, a decoding unit 1004, a color printer 1005, a first code conversion unit 1006, a hard disk drive (HDD) 1007, a second code conversion unit 1008 and a third code conversion unit 1009.

The color printer controller 1001 generates a color image signal 1010.

The compression unit 1002 compresses the color image signal 1010 to first compression data 1011.

The page memory 1003 stores the first compression data 1011 and third compression data 1013 that is to be described later.

The first code conversion unit 1006 converts the first compression data 1011 to second compression data 1012.

The hard disk drive (HDD) 1007 stores the second compression data 1012.

The second code conversion unit 1008 converts the second compression data 1012, which is read out of the HDD 1007, to third compression data 1013.

The decoding unit 1004 decodes the first compression data 1011 or third compression data 1013, which is read out of the page memory 1003.

The color printer 1005 prints a color image signal 1014 that is produced by the decoding.

The third code conversion unit 1009 converts the second compression data 1012, which is stored in the HDD 1007, to fourth compression data 1015.

The color image output apparatus includes a control circuit (not shown) that executes an overall control.

The present apparatus is a known color image output apparatus.

At the time of 1-sheet print, image data that is output from the color printer controller 1001 is converted to fixed-length compression data by the compression unit 1002, and the fixed-length compression data is stored in the page memory 1003. After the fixed-length compression data is stored in the page memory 1003, the fixed-length compression data is subjected to an editing process such as rotation. The resultant data is read out of the page memory 1003 at a fixed rate and is decoded, and the decoded signal is printed by the color printer 1005.

At the time of electronic sort mode, image data that is output from the color printer controller 1001 is compressed and successively converted to second compression data by the first code conversion unit 1006. The second compression data is stored in the HDD 1007. Subsequently, the necessary second compression data is successively read out of the HDD 1007 and converted to third compression data 1013 by the second code conversion unit 1008. The third compression data 1013 is decoded by the decoding unit 1004 and the decoded signal is printed by the color printer 1005.

Next, the compression unit 1002 is described.

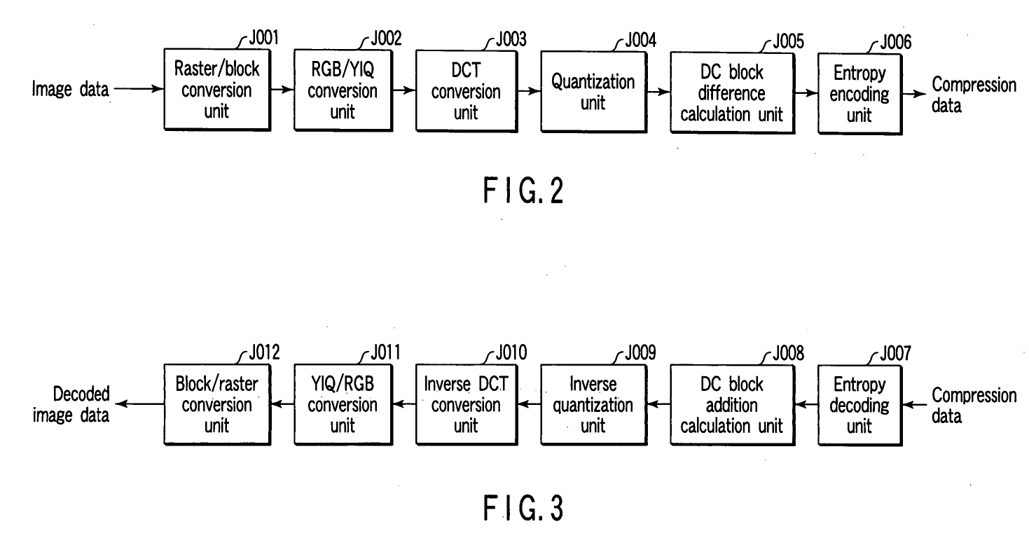

FIG. 2 shows the structure of a JPEG (Joint Photograph Expert Group) compression scheme that is adopted as a standard for image compression. In the JPEG scheme, a raster/block conversion unit J001 converts line-unit data to block data of 8×8 size. An RGB/YIQ conversion unit J002 converts an RGB image signal to a YIQ image signal. A DCT conversion unit J003 subjects each YIQ signal to DCT transform in units of an 8×8 block. A quantization unit J004 executes a quantization process on each DCT coefficient. A DC block difference calculation unit J005 calculates a difference from an adjacent block with respect to only a DC component. An entropy encoding unit J006 executes Huffman coding on a result of 0-run-length processing that is executed in a range from a low frequency to a high frequency.

Each process block in JPEG executes a compression technique that pays attention to the following characteristics.

The raster/block conversion unit J001 converts image data to a unit block so that the image data can be handled as two-dimensional data with high compression efficiency, thereby to frequency-convert an image and to compress the image.

The RGB/YIQ conversion unit J002 converts the image data to luminance/chrominance system data, taking advantage of the fact that the human visual sense is more sensitive to a difference in luminance than to a difference in color.

The DCT conversion unit J003 converts an image signal to a frequency signal for the purpose of compression.

The quantization unit J004 executes quantization so as to more reduce a chrominance signal than a luminance signal, and to more reduce high-frequency signal data than low-frequency signal data (i.e. a greater number of 0s are produced in the quantization result).

The DC block difference calculation unit J005 makes use of the fact that a DC component has a close correlation between adjacent blocks, and executes a difference calculation between adjacent blocks by (process block)−(preceding block) (i.e. a greater number of 0s are produced).

The entropy encoding unit J006 executes run-length coding and Huffman coding by arranging frequency components from a low frequency region to a high frequency region since the number of 0s increases as the frequency becomes higher.

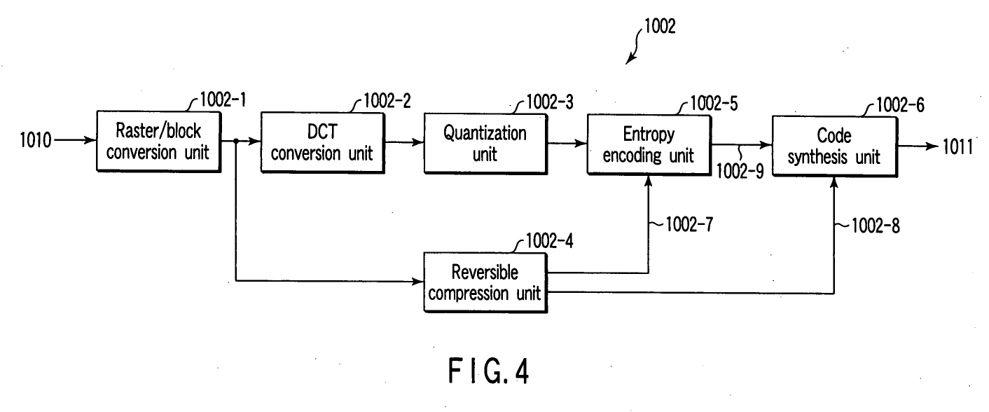

FIG. 3 illustrates decoding of image data. The scheme shown in FIG. 3 executes inverse transform for compressed data. The image data decoding scheme comprises an entropy decoding unit J007, a DC block addition calculation unit J008, an inverse quantization unit J009, an inverse DCT conversion unit J010, a YIQ/RGB conversion unit J011, and a block/raster conversion unit J012.

JPEG standard data is required to have header information that is compression information. In the present invention, however, the header information is not mentioned unless otherwise necessary, since the header information is required only when compressed data is transmitted/received as a file.

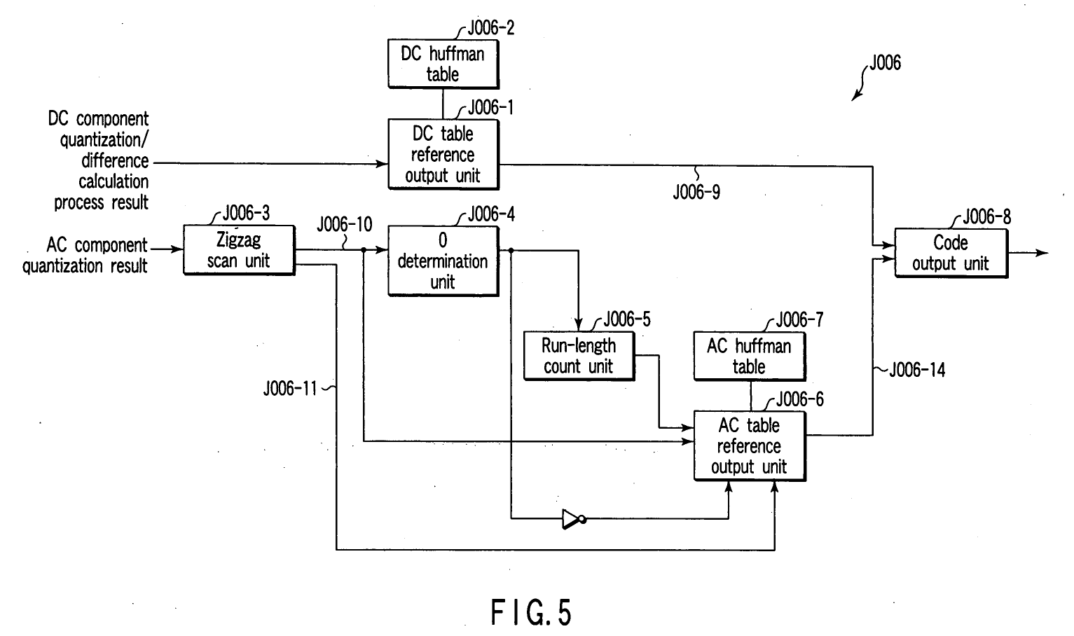

FIG. 4 shows the structure of the compression unit 1002. The structure of the compression unit 1002 differs from the structure shown in FIG. 2 in the following respects. The RGB/YIQ conversion unit J002 and DC block difference calculation unit J005 are not provided. The input image signal is a CMYK signal, instead of an RGB signal. A reversible compression unit is added. The structure of the entropy encoding unit is slightly different. In the other respects, the structure of the compression unit 1002 is basically the same as the structure shown in FIG. 2. The DC block difference calculation unit is not provided since a rotation process is executed on the page memory 1003.

Specifically, the compression unit 1002 comprises a raster/block conversion unit 1002-1, a DCT conversion unit 1002-2, a quantization unit 1002-3, a reversible compression unit 1002-4, an entropy encoding unit 1002-5 and a code synthesis unit 1002-6.

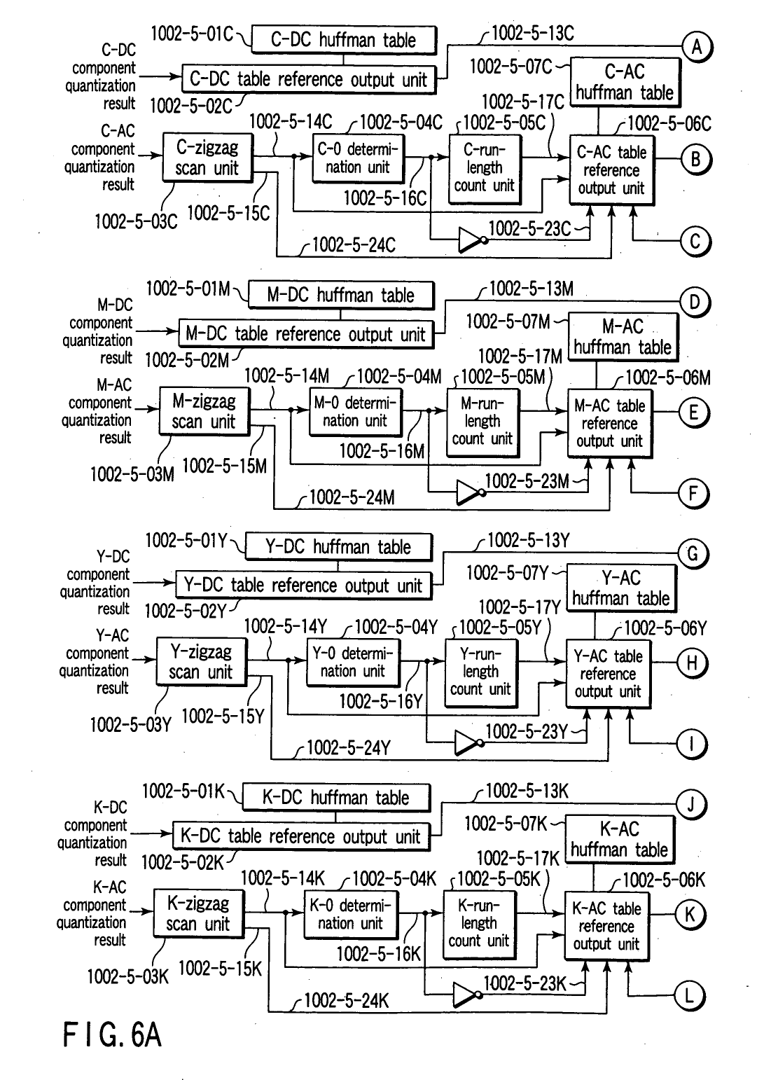

FIG. 5 shows the structure of the JPEG entropy encoding unit J006.

As regards a DC component, a DC table reference output unit J006-1 refers to a DC Huffman table J006-2 and outputs DC component data, which has been subjected to a difference process, as a DC component code J006-9.

As regards an AC component, a zigzag scan unit J006-3 successively zigzag-scans an AC component from a low frequency region to a high frequency region and outputs a resultant frequency component J006-10, and also outputs a scan terminal-end signal J006-11 that indicates whether scan of 1 block ends (=1) or not.

An AC table reference output unit J006-6 executes AC table coding by referring to an AC Huffman table with the following timing:

1) At a time of non-0 data, and

2) At a time of a frequency terminal end.

In the case of (1), encoding is executed by combining non-0 and a run length preceding non-0. In the case of a run length of 16 or more, however, encoding is executed using plural ZRL codes (an integer number of times of a run length of 16), non-zero, and codes of the rest run length.

As regards case (2), encoding is executed by the rule of (1) in the case of non-0. In the case of 0, encoding is executed with an EOB code that indicates that 0s are present up to the terminal end of the block.

At the time of encoding, a run length count unit J006-5 is reset to 0, and a code output unit J006-8 combines the DC component code J006-9 and AC component code J006-14 in units of a block and outputs code data J006-15. In the case of color, a similar process is normally executed on each plane of YIQ.

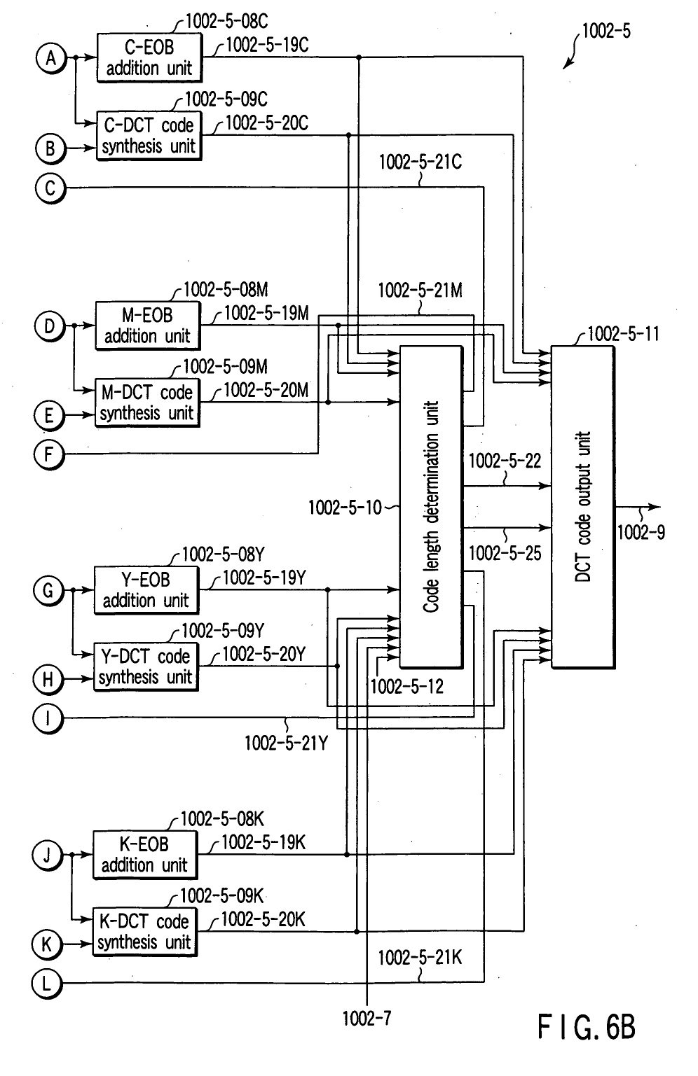

FIG. 6A and FIG. 6B show the structure of the entropy encoding unit 1002-5 according to the present invention. The structural blocks and signals, which are indicated with additional characters of CMYK representative of respective colors, have basically the same operations and only the colors of the object signals are different. Thus, only the operations relating to “C” are described.

A DC component quantization result of a C signal is converted by a C-DC table reference output unit 1002-5-02C with reference to a C-DC Huffman table 1002-5-01C to a DC Huffman code 1002-5-13C.

An AC component quantization result of the C signal is input to a C-zigzag scan unit 1002-5-03C, and the C-zigzag scan unit 1002-5-03C outputs a frequency component 1002-5-14C, which is obtained by successively zigzag-scanning the input result from a low frequency region to a high frequency region, and a scan terminal end signal 1002-5-15C that is indicative of whether a 1-block scan is finished (=1) or not.

A C-0 determination unit 1002-5-04C outputs a signal indicative of whether the frequency component is 0 or not (“1” signal in the case of 0, and “0” signal in the case of non-0).

A C-run-length count unit 1002-05C counts the number of 0s and outputs a signal 1002-5-17C.

A C-AC table reference output unit 1002-5-06C of the C signal outputs an AC component Huffman code 1002-5-18C at three timings: a timing at which a control signal 1002-5-23C is “1”, that is, at a timing at which a quantization value 1002-5-16C is non-0; at a timing at which the scan terminal end signal 1002-5-15C is 1, that is, at a timing of a scan terminal end; and a timing at which a code-length adjusting signal 1002-5-21C (to be described later) is input.

At the above three timings, the C-AC table reference output unit 1002-5-06C outputs the AC Huffman code 1002-5-18C that has the following content.

1) A code that is obtained by combining non-0 and a run length preceding non-0 is output with reference to a C-AC Huffman table 1002-5-07C. If the run length is 16 or more, the run length is expressed by plural ZRL codes (an integer number of times of run-length 16), non-0 and a code of the rest run length.

2) An EOB code that is indicative of a terminal end is output.

With combinations of control signals, the following operations can be expressed:

| 1002-5-23C | 1002-5-24C | |
|---|---|---|
| 0 | 0 | No encoding. |
| 0 | 1 | Encoding of EOB, Encoding |
| | | process and Counter reset. |
| 1 | 0 | Encoding of combination of |
| | | of non-0s, and Counter |
| | | reset. |
| 1 | 1 | Encoding of combination of |
| | | non-0s, End of encoding, |
| | | and Counter reset. |

A C-EOB addition unit 1002-5-08C adds an EOB to the DC component, that is, outputs a code with ALL0 of AC component, as a DC+EOB code 1002-5-19C, to a code length determination unit 1002-5-10 and a DCT code output unit 1002-5-11. A C-DCT code synthesis unit 1002-5-09C outputs a DC+AC code 1002-5-20C, which is obtained by synthesizing a DC-encoding result 1002-5-13C and an AC-encoding result 1002-5-18C, to the code length determination unit 1002-5-10 and the DCT code output unit 1002-5-11.

The same operations are performed with respect to the other colors M, Y and K.

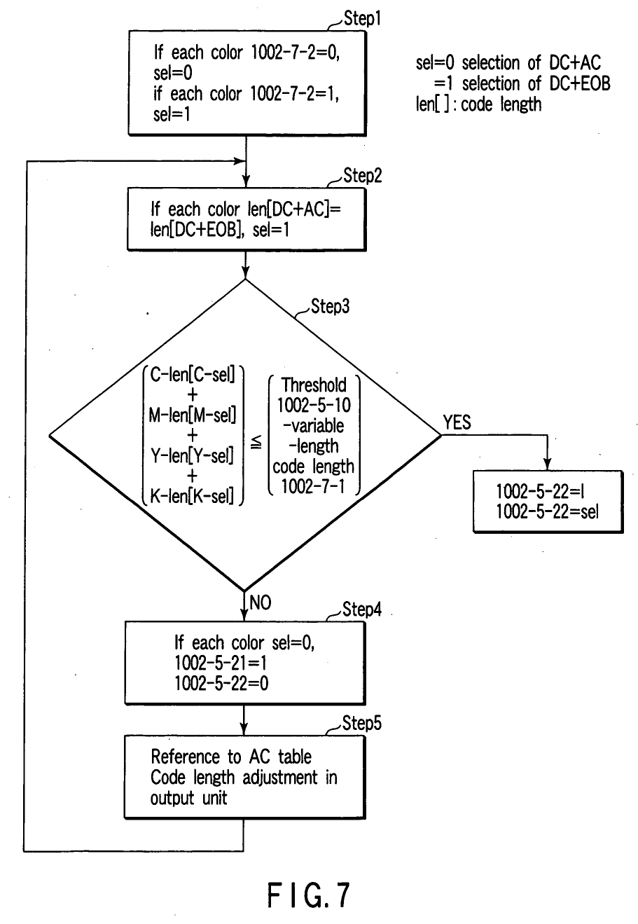

FIG. 7 is a flow chart for explaining the operation of the code length determination unit 1002-5-10.

The code length determination unit 1002-5-10 determines whether a code length of each color component, that is, an AC component, is to be deleted or not, on the basis of a threshold value 1002-5-12, reversible code information 1002-7, DC+EOB codes of CMYK and DC+AC codes (Step 1, 2, 3).

If the code length determination unit 1002-5-10 determines that there is no need of deletion, that is, if the code length is definitive, the code length determination unit 1002-5-10 outputs a signal 1002-5-22 with value “1”, and also outputs a selection signal 1002-5-25 that indicates which of a DC+EOB signal or a DC+AC signal of each color is to be encoded.

If the code length determination unit 1002-5-10 determines that deletion is necessary, it outputs a deletion signal 1002-5-21 in association with a necessary color signal, and also outputs a signal 1002-5-22 with value “0” (Step 4).

If the signal 1002-5-22 is “1”, the DCT code output unit 1002-5-11 selects a DC+EOB code or a DC+AC code with respect to each color of CMYK in accordance with the selection signal 1002-5-25, and outputs an entropy code 1002-9.

The AC table reference output unit 1002-5-06 searches the current codes from the high frequency region and extracts a first non-0 code A and the next non-0 code B with respect to a color signal block with the deletion signal 1002-5-21 of “1”. In addition, the AC table reference output unit 1002-5-06 substitutes a code in which A is changed to EOB after B, executes code length determination once again, and cuts the AC component until a code size of a predetermined threshold is obtained (Step 5).

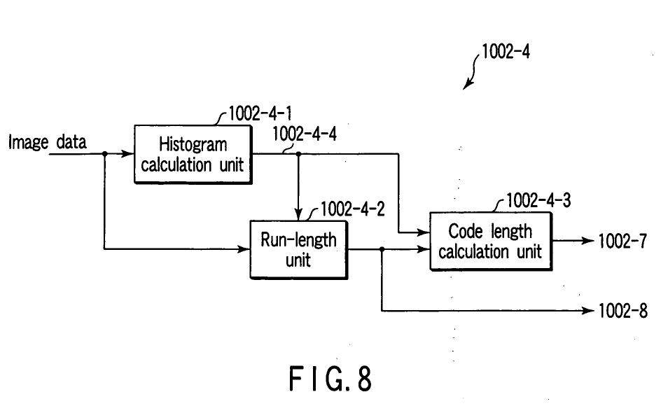

FIG. 8 shows the structure of the reversible compression unit 1002-4 in the present invention.

A histogram calculation unit 1002-4-1 calculates a histogram of each color image signal and outputs a 2-value (binary) signal 1002-4-4 that indicates whether each color is 2-value (binary) (“1” indicates “binary”). A run-length unit 1002-4-2 executes run-length encoding with respect to a signal that has been determined to be binary in the histogram calculation unit 1002-4-1, and outputs a reversible code 1002-8.

A code length calculation unit 1002-4-3 calculates a code length of the reversible code 1002-8 and outputs reversible code information 1002-7 along with the 2-value signal 1002-4-4.

The code synthesis unit 1002-6 synthesizes the entropy code 1002-9 and the reversible code 1002-8 and outputs a code 1011 in which fixed-length reversible code and irreversible code are mixedly present.

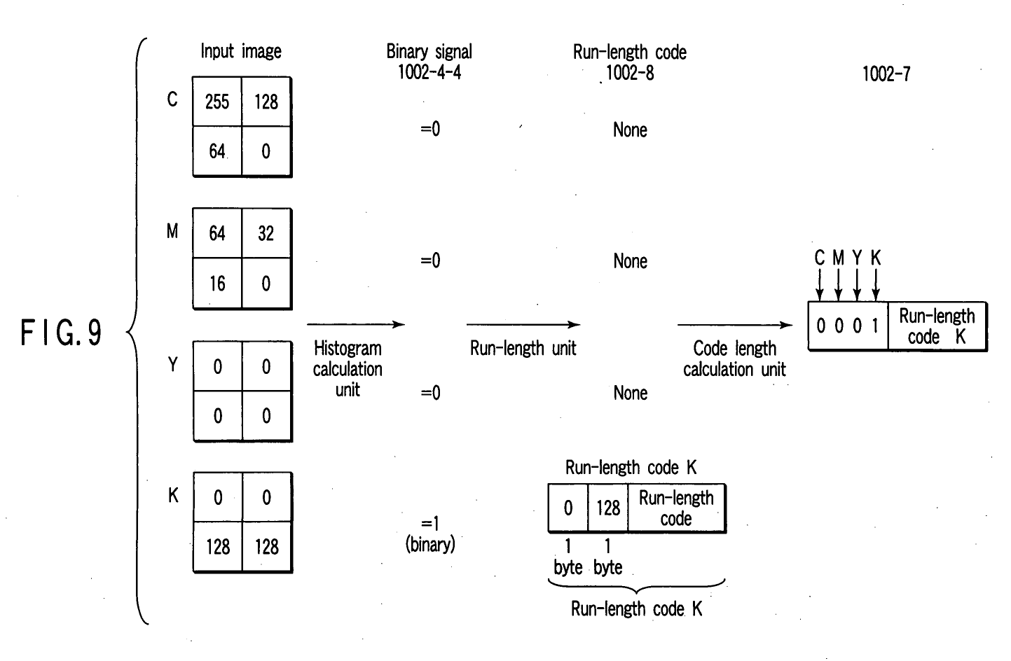

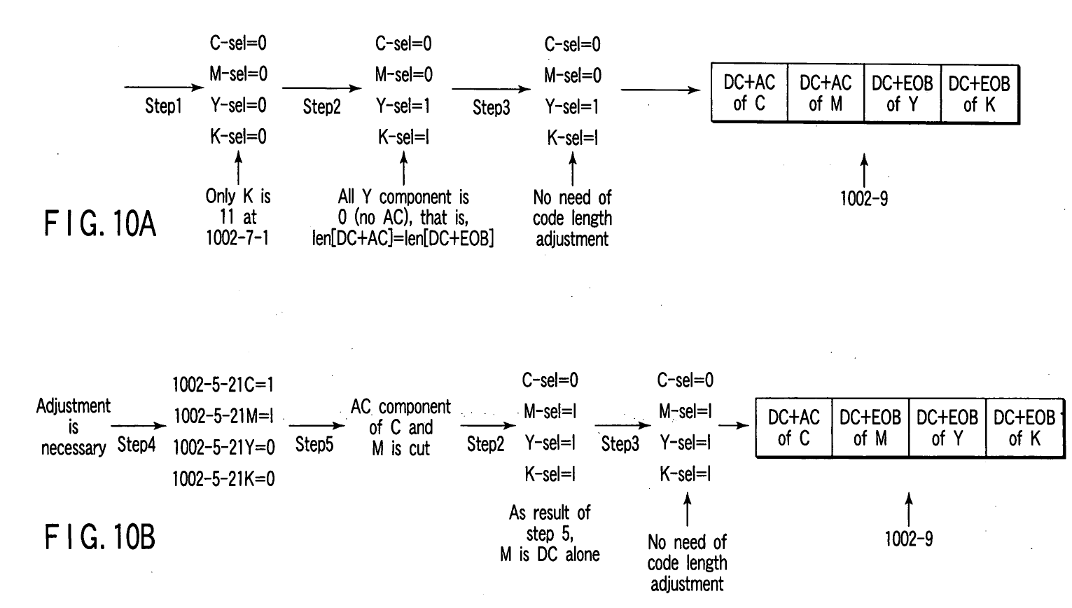

FIG. 9, FIG. 10A and FIG. 10B illustrate the above-described series of operations.

The series of operations is described referring to FIGS. 9, 10A and 10B. Although 1 block has a 8×8 size in fact, the Figures show 1 block having a 2×2 size for the purpose of easier explanation. There is no essential difference in operation.

When the reversible compression unit 1002-4 receives an input image shown in FIG. 9, binary signals 1002-4-4 are all set at 0 (non-binary), except K. Then, the run-length unit of the reversible compression unit 1002-4 combines a run length, which is associated with the binary value, and multi-value information that is to be assigned to 2-states, thereby producing a known run-length code 1002-8. The code length calculation unit of the reversible compression unit 1002-4 stores binary/non-binary states of the respective colors at the first 4 bits, and stores a run-length code length (only K in the present case) of each color after the binary/non-binary states (1002-7).

FIG. 10A and FIG. 10B show states in the respective Steps illustrated in FIG. 7, if the entropy encoding unit 1002-5 receives the quantization value results that are associated with the input images shown in FIG. 9.

FIG. 10A illustrates the case where no re-adjustment of the code length is necessary. Since the K signal is reversibly compressed in Step 1, DC+EOB is selected for K.

In Step 2, the Y signal contains no high-frequency component. Thus, the code length of DC+EOB is equal to the code length of DC+AC, and DC+EOB is selected.

In Step 3, since the sum of the respective colors of CMYK, which is combined with the variable code length, is within the predetermined threshold, the code is output as such.

The code output result 1002-9 is output such that DC+AC is set for C and M and DC+EOB is set for Y and K.

FIG. 10B illustrates the case where adjustment of the code length is determined to be necessary. In step 4, code amount adjustment is executed by setting only the signals 1002-5-21 for C and M at “1”.

As the result of the code amount adjustment in step 5, only the DC component is left for M, and the result, sel=1, is obtained in Step 2.

As the result of the re-determination in Step 3, the code length falls within the predetermined threshold, and the code output result 1002-9 is produced such that DC+AC is set for C and DC+EOB is set for MYK.

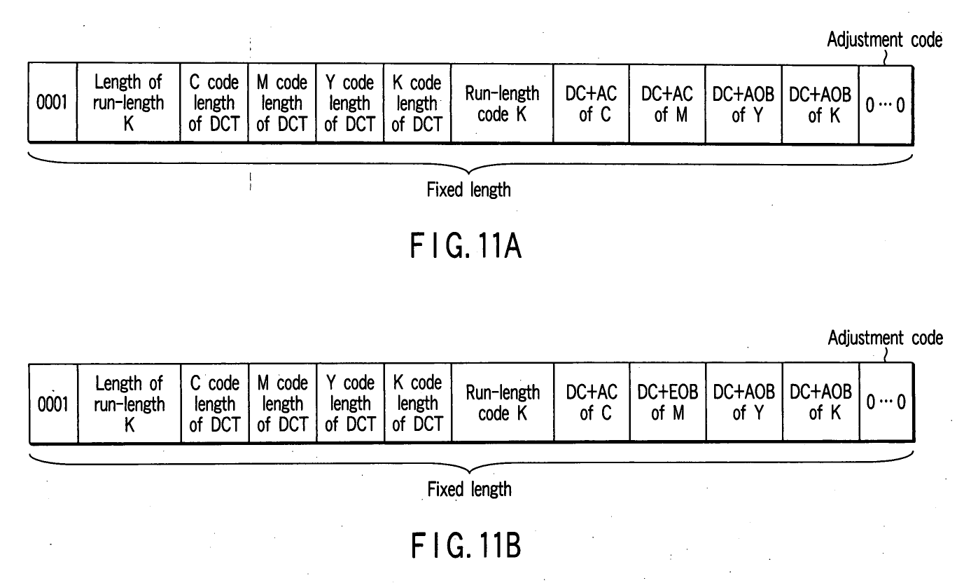

FIG. 11A and FIG. 11B show finally formed codes 1011. Codes with desired fixed-length code amounts are obtained by the combinations of reversible codes and irreversible codes, the lengths of respective color components of reversible/irreversible codes and adjustment codes.

By the above-described operations of the encoding unit, the fixed-length code, in which the reversible compression scheme and irreversible compression scheme are mixedly present, is obtained. An encoding scheme, which is suitable for a signal with several gray levels of, e.g. a character, is selected for the reversible coding. An encoding scheme, which is suitable for a signal with many gray levels of, e.g. a photo, is selected for the irreversible coding. As regards reversible encoding, only an arbitrary color signal is selected. As regards a reversibly compressed color signal, only a DC component is compressed by irreversible compression.

In the above-described structure of the present embodiment, the DC component is left only in the irreversible process side. For example, an averaging process stage may be provided in front of the run-length unit 1002-4-2, and an averaged signal, instead of a run length, may be stored at the time of non-binary values. Thereby, the DC component may always be included in both the reversible and irreversible codes.

As regards the method of cutting the AC component, after the AC component is calculated, the DC+EOB code is separately formed by ignoring the AC component. Needless to say, in the case where only the DC component is needed, the image that is input to the DCT conversion unit may be averaged and the data may be processed so as not to produce an AC component.

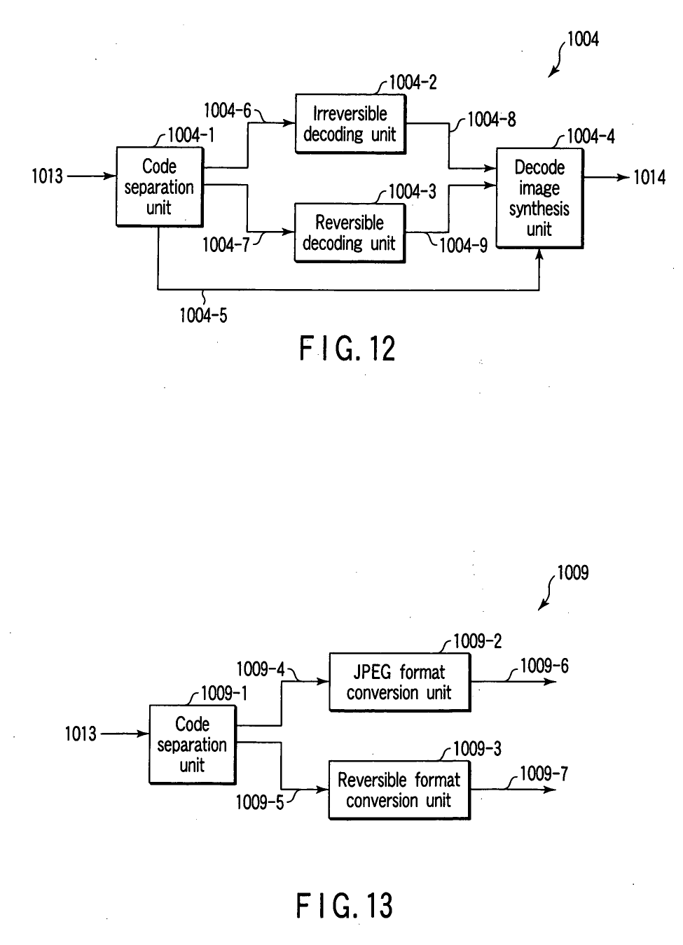

FIG. 12 shows the structure of the decoding unit 1004 shown in FIG. 1. The decoding unit 1004 comprises a code separation unit 1004-1, an irreversible decoding unit 1004-2, a reversible decoding unit 1004-3 and a decoded image synthesis unit 1004-4.

The code separation unit 1004-1 separates the input data into a reversible code 1004-7 and an irreversible code 1004-6. In addition, the code separation unit 1004-1 generates a reversible color data signal 1004-5 that indicates which color data is reversibly encoded.

The irreversible decoding unit 1004-2 executes color separation based on DCT code length information of each color, inputs the separated color data to conventional JPEG decoders in parallel, and outputs an irreversible decoded signal 1004-8.

The reversible decoding unit 1004-3 executes conventional run-length decoding, assigns multi-value signals to 2-states, and outputs a reversible code signal 1004-9.

The decoded image synthesis unit 1004-4 replaces only the reversibly decoded color-plane data of the irreversible decoded signal 1004-8 with the reversible code signal 1004-9 in accordance with the reversible color-plane signal 1004-5, and produces a decoded image signal 1014.

The compression data 1011 shown in FIG. 1 is stored in the page memory 1003, with its fixed-length being maintained. The operation that is executed between the page memory 1003 and HDD 1007 is as follows. The first code conversion unit 1006 deletes the adjustment code (shown in FIG. 11) from the compression data 1011, and the resultant data is stored in the HDD 1007 as variable-length data. At the time of readout from the HDD 1007, the compression data is converted by the second code conversion unit 1008 to the compression data 1013 to which the adjustment code is added, so that the fixed-length data is similarly produced. The compression data 1013 is stored in the page memory 1003.

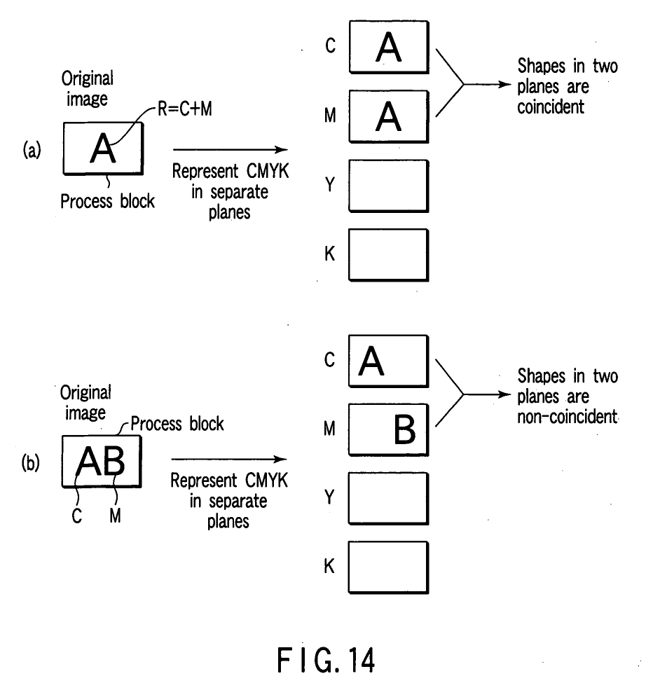

FIG. 13 shows the structure of the third code conversion unit 1009 shown in FIG. 1. The third code conversion unit 1009 comprises a code separation unit 1009-1, a JPEG format conversion unit 1009-2, and a reversible format conversion unit 1009-3.

In the third code conversion unit 1009, the code separation unit 1009-1 separates the data, which is stored in the HDD 1003, into a reversible code 1009-4 and an irreversible code 1009-5.

On the irreversible coding side, the JPEG format conversion unit 1009-2 adds information, such as a marker and a header, to the irreversible code information from which code length information, etc. is removed, thus converting the code information to a standard JPEG file format and producing a JPEG file 1009-6.

On the reversible coding side, the reversible format conversion unit 1009-3 inserts a code, which is obtained by reversibly encoding 0, into a block in which a reversible code is not included, thus converting the input code information to a format comprising reversible codes alone and producing a reversible file 1009-7.

In the JPEG file 1009-6, as regards a reversibly compressed color plane, color data comprising a DC component alone is also stored. Thus, binary information such as characters is lost, but an outline of an image is understandable. Of course, if the code amount is sacrificed and the process of converting the reversible color plane to the DC alone in step 1 in FIG. 7 is not executed, the high-frequency component is left and the image quality is enhanced.

Since the reversible file includes binary (2-value) information, such as characters, as main part, it can be decoded and can easily be subjected to an OCR process.

As has been described above, if the DC component is stored on the reversible coding side without fail, the precision of OCR is improved. In addition, if the reversible data is replaced with the result of decoding of the DC component of the irreversible code, the precision can similarly be improved without increasing the code amount.

In the present embodiment, the DC component is left on the irreversible coding side. Alternatively, the DC component may be left on the reversible coding side. In this case, the conversion of the JPEG file can be executed only by replacing the pre-provided code of the DC component code with one selected from results of decoding of the reversible data. Therefore, if the decoding of the reversible code is easier, the replacement of the DC component is realized more easily.

In the present embodiment, the selection of the reversible image has been described on condition that the image data is binary data. In the case of placing importance on the re-use of OCR, etc., if preference is given to characters and one of CMYK which tends to be easily conspicuous in degradation in image quality, the amount of reversible codes decreases and thus the amount of codes that are stored in the HDD is reduced. Therefore, the OCR precision of the reversible file comprising characters alone is improved. For example, selection is executed in the order of priority of KCMY.

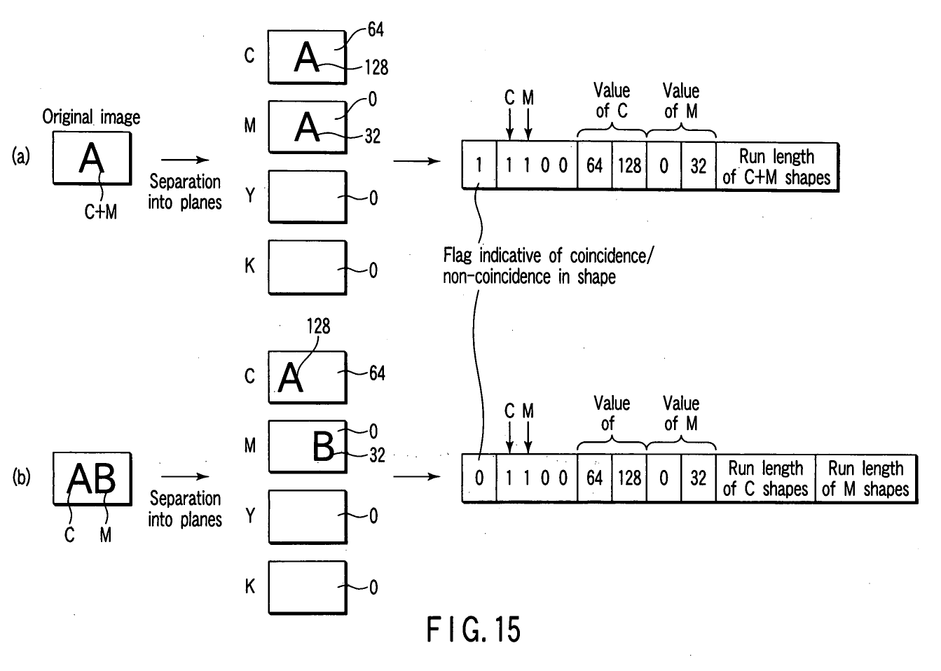

FIG. 14 shows multi-color character patterns that are present within process blocks. Part (a) of FIG. 14 shows the case where the hue of a character is expressed, and part (b) of FIG. 14 shows the case where characters with different colors are formed.

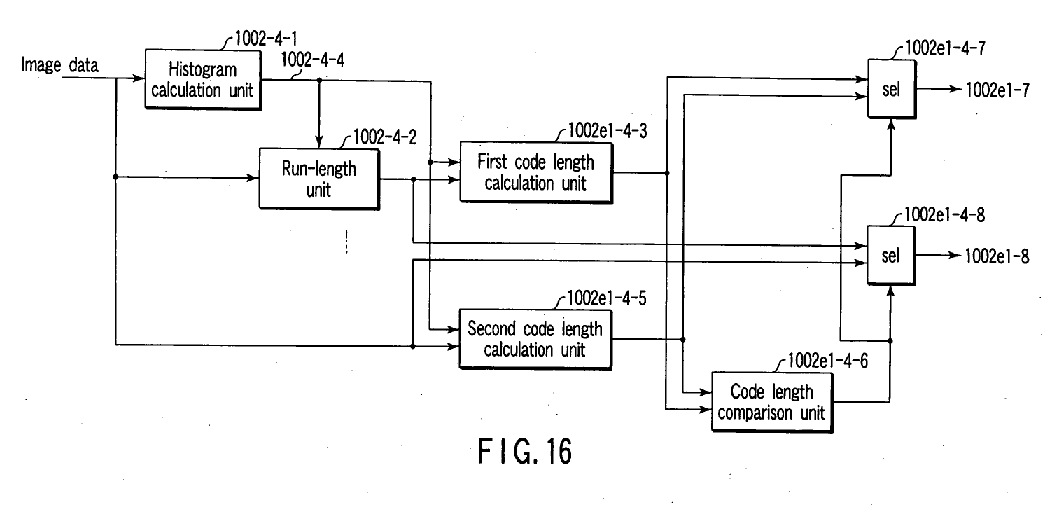

In the case of (a), even if only a C plane is left and M is subjected to irreversible processing, the OCR precision is unchanged. In the case of (b), the OCR precision is degraded unless both C and M are left. In this case, for example, if the run-length codes are configured as shown in FIG. 15, the code amount and the OCR precision can be improved.

Needless to say, the present process can improve the code amount even where the process is not applied to OCR, compared to the scheme in which the reversible code is simply calculated with respect to each color plane.

Moreover, the object of reversible processing is determined by extracting binary (2-value) information. However, it is obvious that objects of reversible processing may extended to 3-value to several-value information.

In the structure of this embodiment in which compression is executed with two schemes of reversible compression and irreversible compression, if a problem arises with the image quality, the problem can be solved by simply increasing the number of object patterns on the reversible process side. In this case, there is no need to make change in both the reversible and irreversible process sides. Only the reversible process side may be changed. In other words, if the reversible process side is configured with an easy-to-change circuit, the time for change can be shortened.

Next, a first modification of the first embodiment is described.

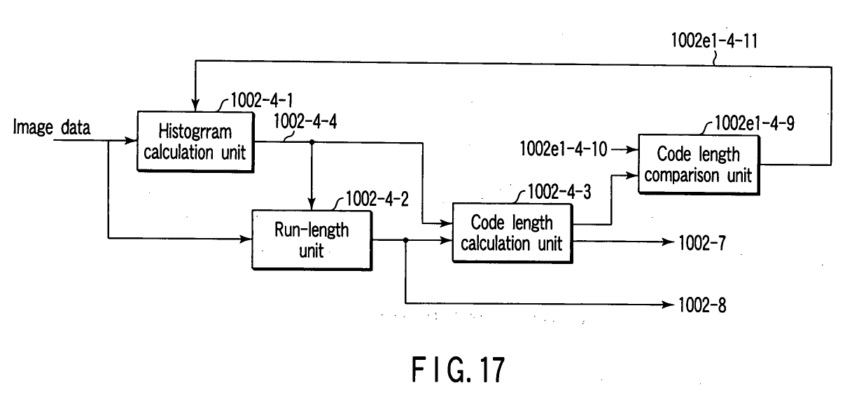

FIG. 16 shows the structure of a reversible compression unit 1002-4 according to a first modification of the first embodiment. The code length calculation unit 1002-4-3 shown in FIG. 8 is replaced with a first code length calculation unit 1002e1-4-3 and a second code length calculation unit 1002e1-4-5. This reversible compression unit 1002-4 further includes a code length comparison unit 1002e1-4-6, a selector 1002e1-4-7 and a selector 1002e1-4-8. In the other respects, the structure of this first modification is basically the same as the structure of the first embodiment, so the common parts are denoted by like reference numerals and a description thereof is omitted.

The first code length calculation unit 1002e1-4-3 calculates the length of image data. The second code length calculation unit 1002e1-4-5 also calculates the length of image data.

The code length comparison unit 1002e1-4-6 compares both code lengths and outputs the code with the shorter length and the associated code information as signals 1002e1-7 and 1002e1-8 via the selectors 1002e1-7 and 1002e1-8.

With the structure of this embodiment, it is ensured that the reversible code size is limited to a predetermined size or less (the original image in this example).

Although not shown, in the present embodiment, it is possible that the reversible code may be a run-length code or a non-compressed code. Thus, the code format is configured to be able to distinguish both. In the subsequent process, correction is made on the basis of this presupposition.

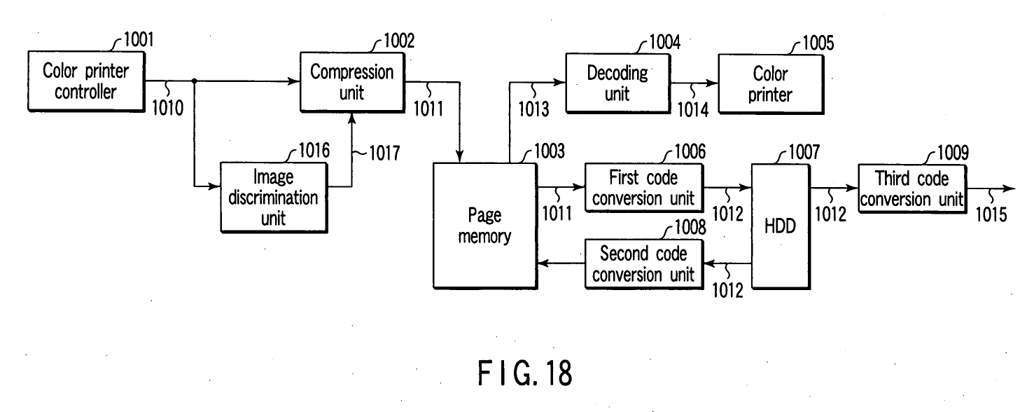

In the present embodiment, the adjustment of the code length is made in comparison with the original image size. Needless to say, the invention is not limited to this embodiment. For example, as shown in FIG. 17, a code length comparison unit 1002e1-4-9 may be provided as in the case of the irreversible process. The code length comparison unit 1002e1-4-9 executes comparison with a threshold value 1002e1-4-10. A comparison result 1002e1-4-11 may be fed back to a block that selects an object of reversible encoding, such as the histogram calculation unit 1002-4-1.

Next, a second modification of the first embodiment is described.

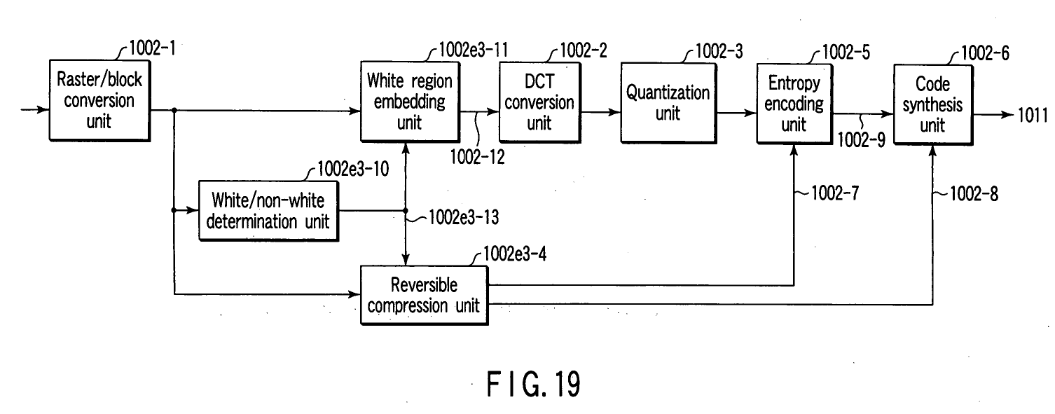

FIG. 18 schematically shows the structure of a color image output apparatus according to the second modification of the first embodiment. In the second modification, an image discrimination unit 1016 is added to the structure shown in FIG. 1. The parts common to those in FIG. 1 are denoted by like reference numerals, and a description thereof is omitted.

In the second modification, the structure of the compression unit 1002 includes the code length comparison unit 1002e1-4-9 shown in FIG. 17. The method of supplying the threshold value 1002e1-4-10 for the reversible code is different.

The image discrimination unit 1016 is a conventional image discrimination device and discriminates whether the attribute of an image is a character or a photo. In units of a compression process block, the image discrimination unit 1016 outputs a determination result 1017.

Based on the determination result 1017, the compression unit 1002 increases the code amount of the reversible coding if the block is a character (i.e. increases the threshold value 1002e1-4-10), and decreases the code amount of the reversible coding if the block is a photo. The code amount that is assigned to the irreversible coding has an inverse-proportional relation since the code amount of (reversible code+irreversible code) has the fixed length.

Since the code amounts that are assigned to the different coding schemes dynamically vary depending on the characteristics of the image, a code with a higher degree of freedom in image quality and compression ratio can be obtained.

In the structure of the present embodiment, the discrimination process is added. In the case of a printer controller that outputs image signals and tag information that is an attribute of an object, a structure that uses the tag information may be possible.

Instead of block-unit switching, it is possible to execute switching in association with page-unit information, e.g. a print mode of a printer. Furthermore, for a re-use other than a use for printing of codes, switching may executed depending on whether preference is given to principal handling of an image file such as a JPEG file or to some other process such as OCR.

Next, a third modification of the first embodiment is described.

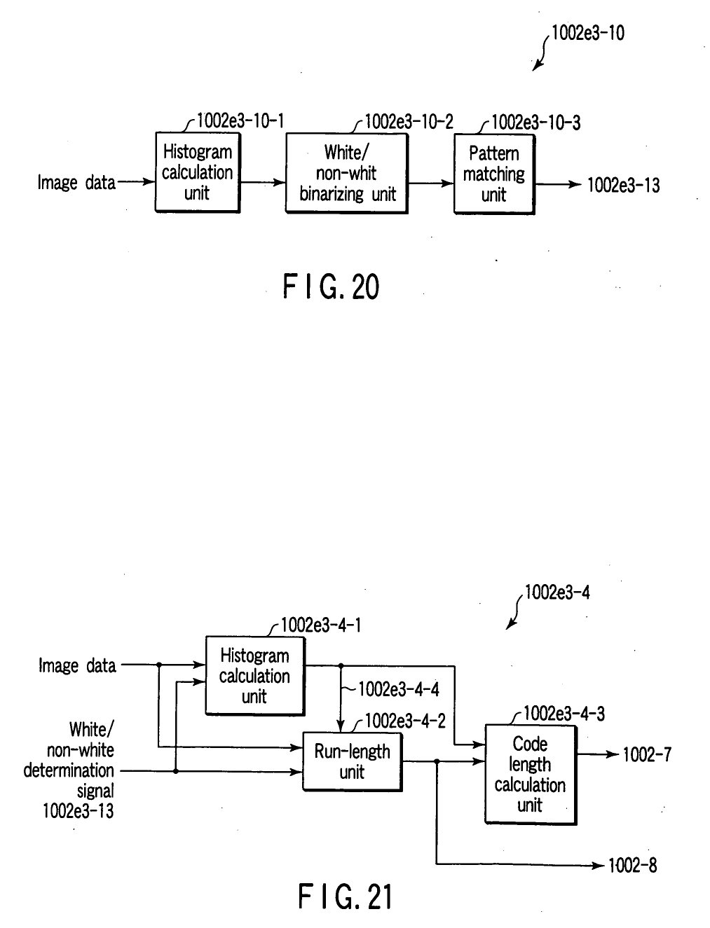

FIG. 19 shows the structure of a compression unit 1002e3 according to the third modification of the first embodiment. The third modification differs from the first embodiment with respect to the structure of the compression unit and the structure of the decoding unit.

The compression unit 1002e3 shown in FIG. 19 additionally includes a white/non-white determination unit 1002e3-10, a white region embedding unit 1002e3-11, an image signal 1002e3-12 and a white region determination signal 1002e3-13. The compression unit also includes a reversible compression unit 1002e3-4 in association with these additional components. The parts common to those in the first embodiment of FIG. 4 are denoted by like reference numerals, and a description thereof is omitted.

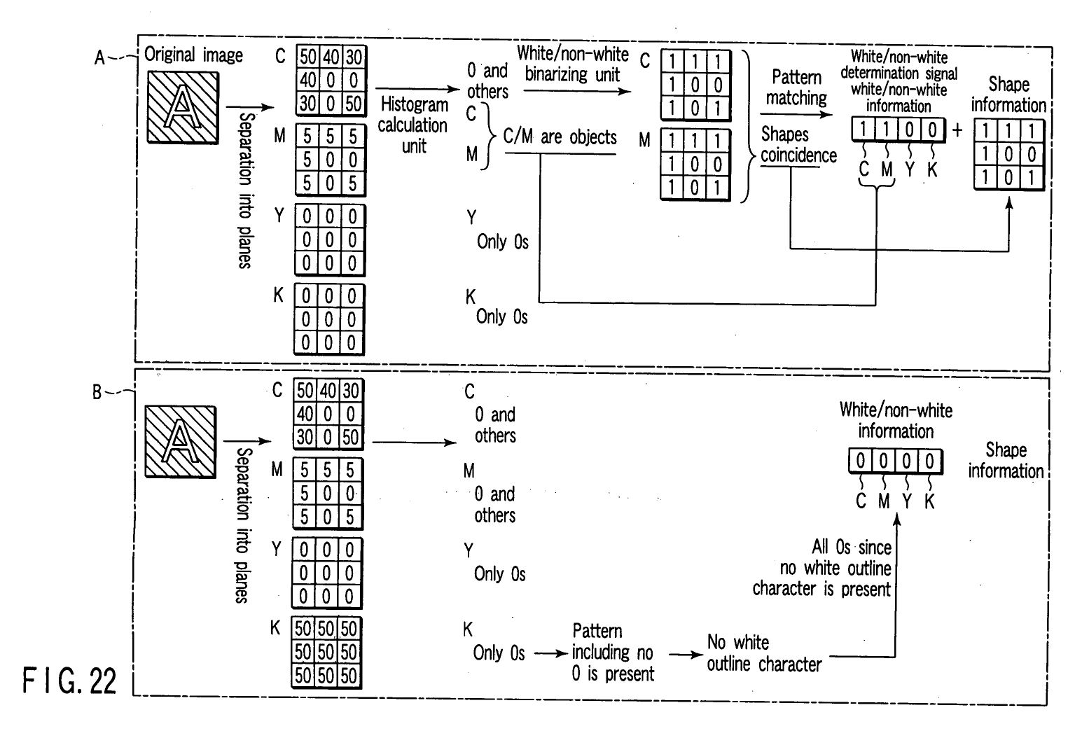

FIG. 20 shows the structure of the white/non-white determination unit 1002e3-10. The white/non-white determination unit 1002e3-10 comprises a histogram calculation unit 1002e3-10-1, a white/non-white binarizing unit 1002e3-10-2 and a pattern matching unit 1002e3-10-3.

The histogram calculation unit 1002e3-10-1 examines a distribution of values of respective color planes in the block. The white/non-white binarizing unit 1002e3-10-2 executes binarization using white (0) and non-white (1) with respect to the planes of two or more values including white. The pattern matching unit 1002e3-10-3 executes matching and determines whether the shapes of respective planes are coincident or not. If the shapes are coincident, “1” is determined. If not, “0” is determined.

In this way, the white/non-white determination unit 1002e3-10 has determination information for respective color planes and combines the determination information with the associated shape information, thereby producing the white/non-white determination signal 1002e3-13.

The white region embedding unit 1002e3-11 executes an embedding process of embedding a white-region pixel value with a non-white-region pixel value on the basis of the shape information, with respect to the object color plane according to the white/non-white determination signal 1002e3-13.

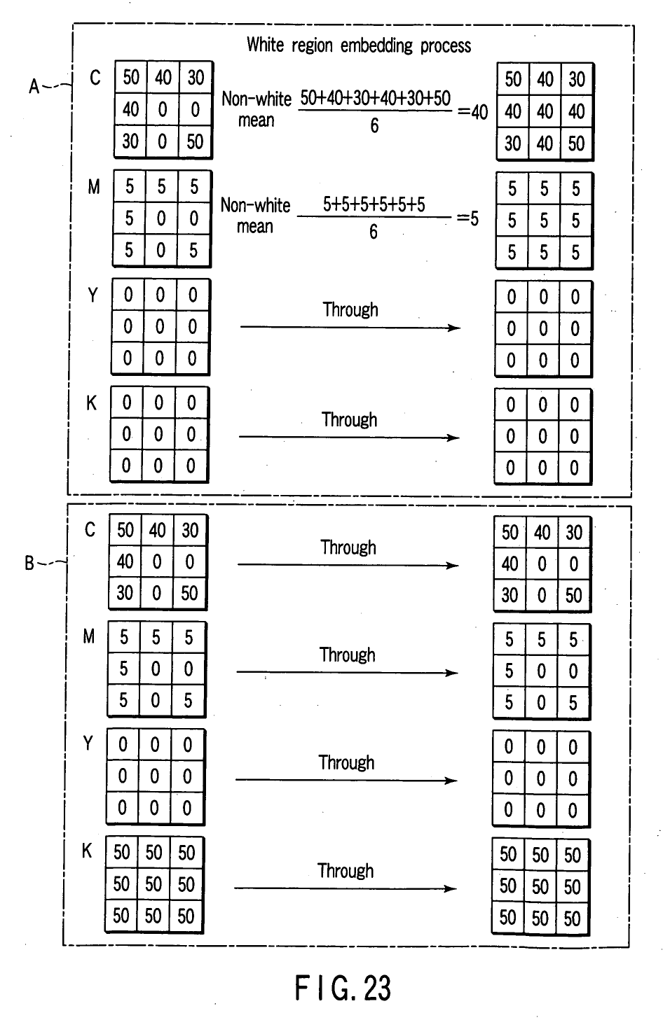

FIG. 21 shows the structure of the reversible compression unit 1002e3-4. The reversible compression unit 1002e3-4 comprises a histogram calculation unit 1002e3-4-1, a run-length unit 1002e3-4-2 and a code length calculation unit 1002e3-4-3.

As is shown in FIG. 21, in the reversible compression unit 1002e3-4, the white/non-white determination signal 1002e3-13 is input to the histogram calculation unit 1002e3-4-1 and run-length unit 1002e3-4-2. In the reversible compression unit 1002e3-4, if a plane occurs in which the white/non-white determination signal 1002e3-13 is effective (=1), the run-length unit 1002e3-4-2 subjects the associated shape information to run-length compression. If not, the reversible compression unit 1002e3-4 executes normal operations.

In this case, although not shown, a discrimination code for discriminating a normal binary run length and a white/non-white run length is added to the code.

According to the decoding unit 1004 of the third modification, in the structure shown in FIG. 12, when a block that is determined to be white/non-white is decoded, reversible plane information is preferentially used for a pixel that is determined to be white by the decoded image synthesis unit 1004-4, and an irreversible plane is selected for a pixel that is determined to be non-white. Thereby, a decoded image 1014 is generated. Specifically, in the first embodiment, a color plane that includes a reversible plane is simply replaced on a color-plane-by-color-plane basis. In this modification, as regards a white/non-white plane, reversible information is used for only white pixels in the object color plane.

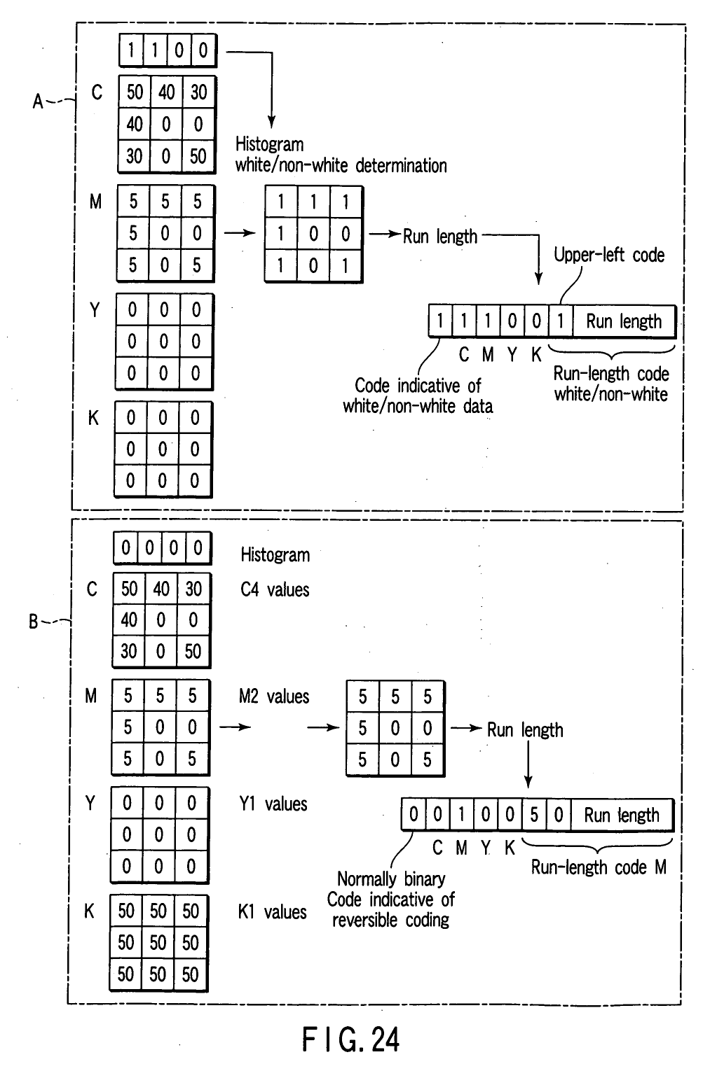

Next, the operation from the compression to the decoding is described, referring to an example of a white outline character. FIG. 22 illustrates an operation in the case of using the present invention and an operation in the case of not using the invention.

The white/non-white determination unit 1002e3-10 operates as follows. When there is an image indicated in part A in FIG. 22, the histogram calculation unit 1002e3-10-1 finds that CM planes comprise white and non-white and YK planes comprise 0s. Then, the white/non-white binarizing unit 1002e3-10-2 generates binary information for only the CM planes, and pattern matching is executed. Since the shapes are coincident, information of a white/non-white object plane and shape information are output with respect to only CM.

In the case of an image indicated by part B in FIG. 22, CM planes comprise white and non-white. Since the K plane comprises no white information, the associated block is not determined to be white outline character information. All of CMYK planes are determined to be not a white/non-white condition.

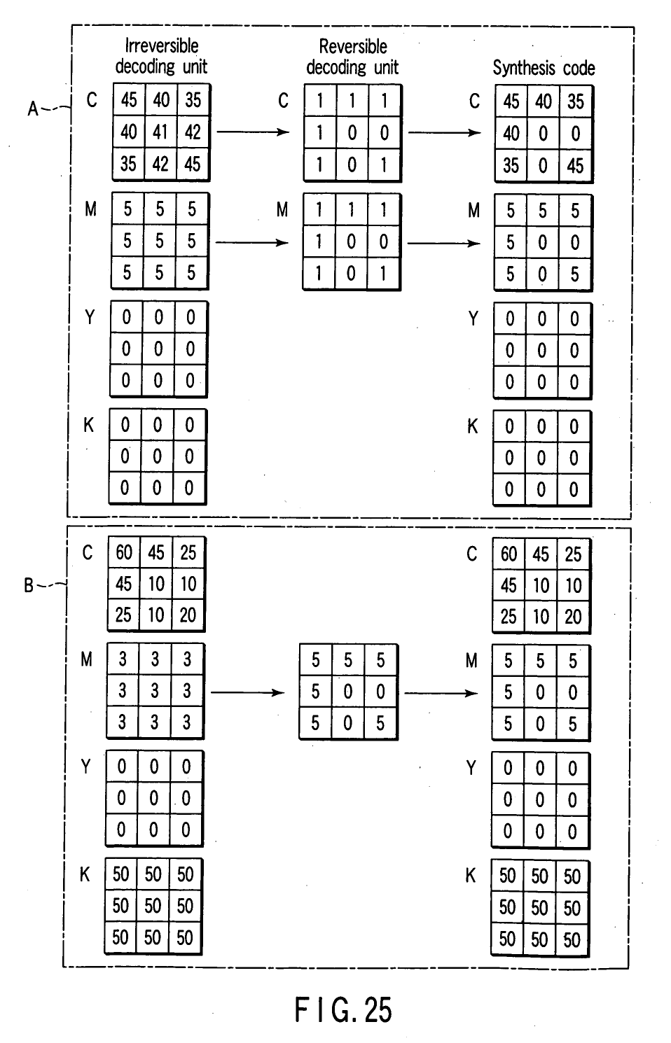

Next, the white region embedding unit 1002e3-11, as shown in FIG. 23, generates images that are embedded with neighboring pixel values, with respect to only C and M patterns that are indicated by part A in FIG. 22.

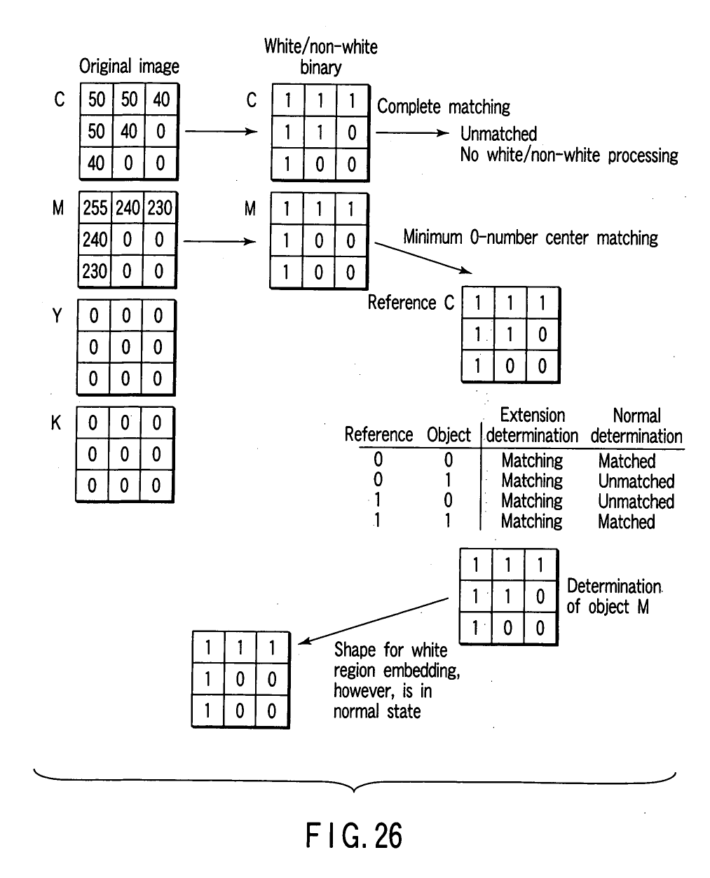

In the reversible encoding unit 1002e3-4, as shown in FIG. 24, white/non-white information is treated as a reversible compression object with respect to part A, and CM data are used as object patterns and accompanied with discrimination code “1”. Part B relates to a normal binary reversible process, and thus only the M plane is subjected to reversible processing. As regards the white/non-white run length, information indicative of the start pixel of the run is added in place of 2 bytes indicative of the binary state in the binary reversible processing.

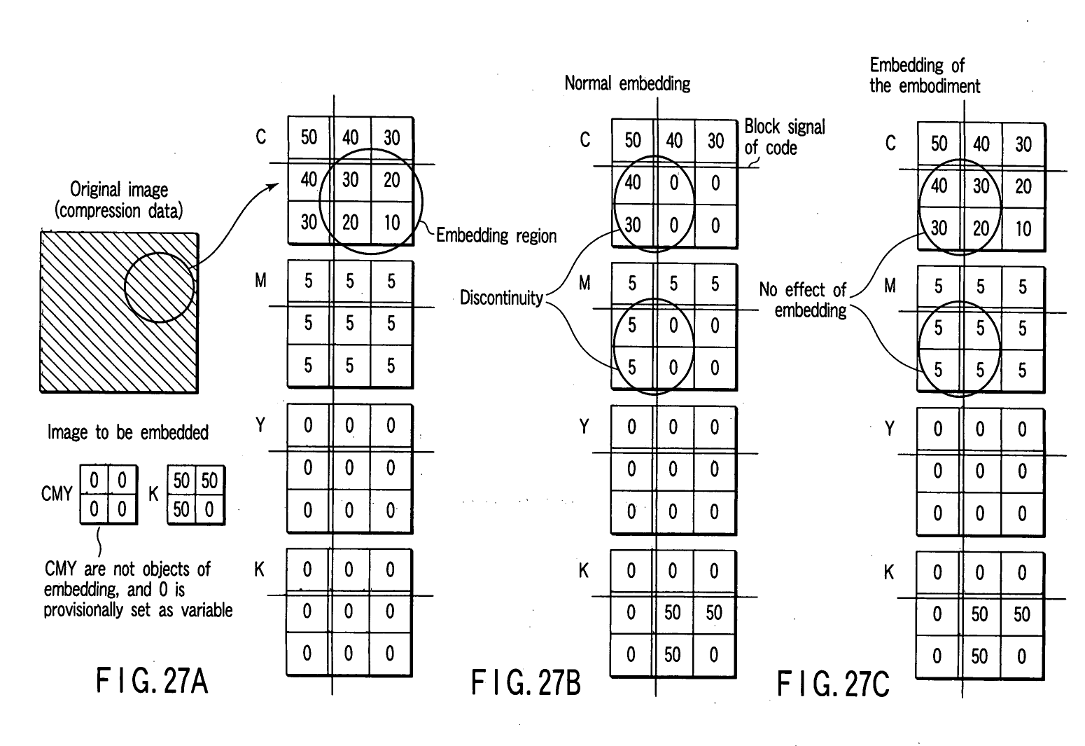

Next, a decoded result of the decoding unit 1004 in the third modification is described referring to FIG. 25.

The result of the irreversible decoding unit 1004-2 by DCT is conspicuous in the C plane that is associated with the non-binary state in the original image. As is understood from FIG. 25, in part A, white regions are subjected to embedding processing. Thus, a variation in non-white regions is less than in part B of FIG. 25. Further, the embedded white regions are corrected to white by synthesis decoding. If attention is paid to only the C plane, the effect of the present process can remarkably be understood.

In other words, with the introduction of the white/non-white process, the white state of the original image can be kept. In addition, since the white regions are subjected to the embedding process prior to the irreversible compression, the variation in the non-white regions is suppressed. The reason is that the frequency transform scheme is used in the irreversible encoding, and the white/non-white image that has a large variation is the process object. Thus, if the image is compressed after the variation is reduced, the degradation in image quality can be suppressed, and the advantage relating to the code amount is obtained.

In the present embodiment, in order to reduce the variation, replacement is executed using the mean value of non-0 regions. Alternatively, other process schemes using, e.g. the mean value of blocks or an embedding process for neighboring non-0 pixels, may be adopted, although the advantageous effects vary from process to process.

In the present embodiment, the M plane comprises binary white/non-white. It is understood that the reversible encoding is successively executed, like the ordinary binary reversible process. In particular, the white outline character has been exemplified for the reason that if some value is reproduced in a pixel region containing no data, such reproduction would be conspicuous. It is obvious, however, that a higher image quality of a C plane shown in part B of FIG. 25 can be achieved in the case of using, as an object, a character that is not a completely white outline character as in part B of FIG. 25, if the determination condition is altered.

The object, with which the N-value states are set as binary states, is not limited to white/non-white, and image information of importance may be used.

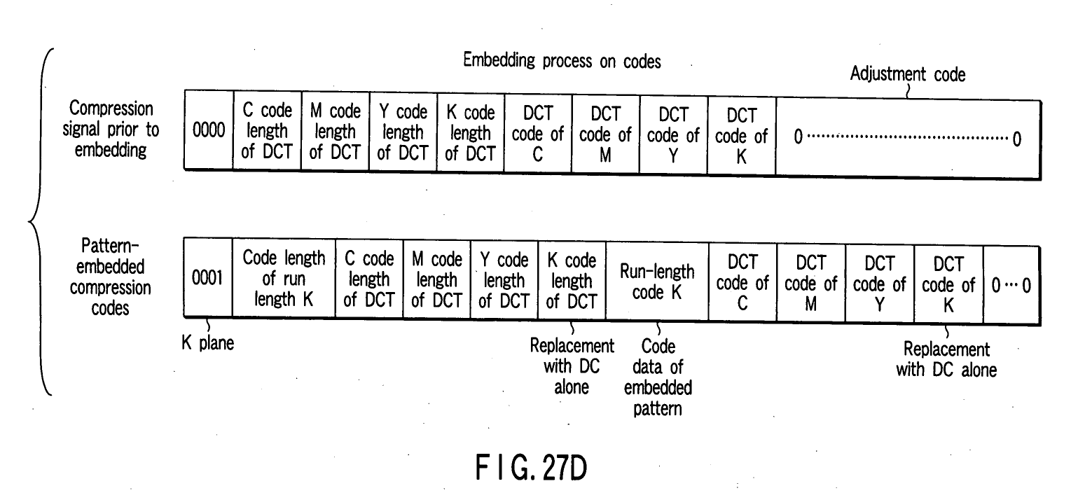

In the present embodiment, the completely white outline character is treated as the object. For example, in order to process patterns as shown in FIG. 26, pattern matching may be executed using, as a standard, a plane that contains minimum white pixels. White/non-white shape information of each pattern is fed to the white region embedding unit 1002e3-11 and the embedding process is executed. Thereby, the image quality is enhanced.

In the present embodiment, C and M are objects of white/non-white binarization. The number of white regions is in the relationship of C<M. Thus, C is used as a standard, and a region where the standard is non-white is regarded as a coincident region even if the object is white or non-white. Determination is made only with respect to whether the standard white regions are coincident.

It becomes possible to increase the number of patterns in which the image quality of minimum regions, which are to be secured as the white outline character, can be improved.

Next, a fourth modification of the first embodiment is described.

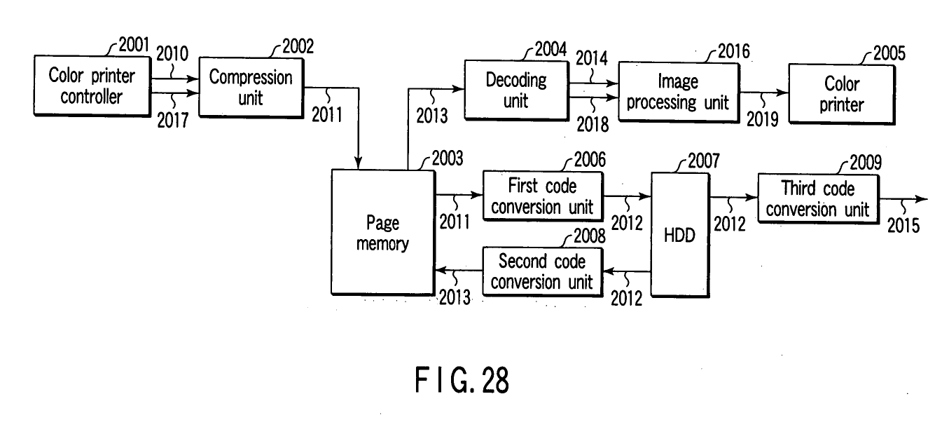

The operation of the fourth modification of the first embodiment is described referring to FIGS. 27A, 27B, 27C and 27D. The fourth modification is basically the same as the first embodiment. The difference is that an operation scheme for the page memory 1003 is added.

As shown in FIG. 27A, there is a request for adding a character, etc. to compression data.

Normally, compressed data is embedded in a pre-provided image. The present scheme is basically the same as this. However, if embedding is simply executed, background data for embedding is ignored. As a result, as shown in FIG. 27B, embedded regions become non-uniform.

In the present scheme, a plurality of encoding schemes can be mixedly applied to the same pixel position in the respective color planes. As is shown in FIGS. 27C and 27D, information may be added to specified color patterns. In addition, in the case of a character, significant information such as a character may be added to a reversible code, and replacement is executed using data in which a DC component code is added to an irreversible code. Thereby, information can be added without affecting other color planes, that is, without losing continuity. If the code amount permits, a K reversible plane may simply be added.

Besides, the handling of white/non-white information, which has been described in connection with the third modification of the first embodiment, may be added. In this case, even if some information is present on a color plane associated with information to be added, a character may be embedded as white/non-white reversible information. Thereby, embedding can be executed without losing continuity of object color planes.

In the present embodiment, as regards reversible/irreversible information, the reversible information is preferentially decoded, and the object is a document. Thus, embedding is executed for reversible information. However, it is obvious that embedding can be executed for one of a plurality of code data or an arbitrary code in accordance with a decoding rule or insertion information.

In addition, it is obvious that since the data on the page memory has a fixed length, embedding is executed with a data amount in a predetermined fixed-length code amount range. Alternatively, only when the data amount exceeds the range, decoding/re-compression is executed for embedding, or the position of embedding is changed. In this way, the rule associated with the fixed-length data is used. It is also obvious that there are no such constraints for the third code conversion unit 1009 that is free from the handling with the fixed-length data.

Next, a second embodiment is described.

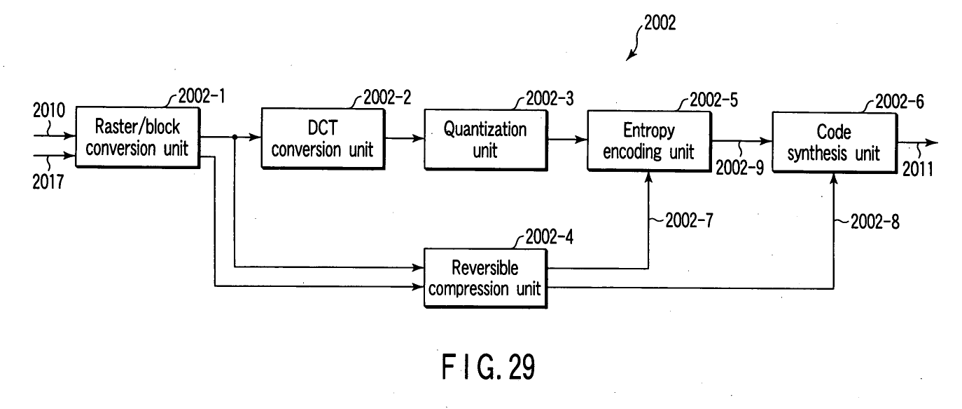

FIG. 28 schematically shows the structure of a color image output apparatus according to the second embodiment. The color image output apparatus comprises a color printer controller 2001, a compression unit 2002, a page memory 2003, a decoding unit 2004, a color printer 2005, a first code conversion unit 2006, a hard disk drive (HDD) 2007, a second code conversion unit 2008 and a third code conversion unit 2009.

In the color image output apparatus according to the second embodiment, the color printer controller 2001 is configured to output a color image signal 2010 and a binary discrimination signal 2017 that is representative of the attribute of the image.

The compression unit 2002 compresses both the color image signal 2010 and discrimination signal 2017. The decoding unit 2004 produces, by decoding, a decoded color image signal 2014 and a decoded discrimination signal 2018.

An image processing unit 2016 corrects the decoded color image signal 2014 from the decoding unit, on the basis of the decoded discrimination signal 2018, and produces a color image signal 2019.

The color printer 2005 executes printing based on the color image signal 2019.

The second embodiment is basically the same as the first embodiment, except that the discrimination signal 2017 is added as an input, and the associated processes are added and modified.

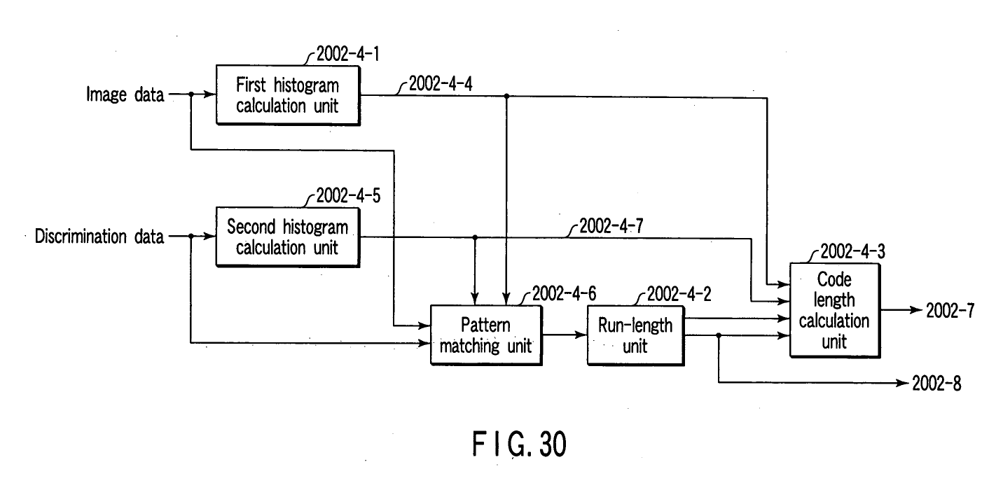

FIG. 29 shows the structure of the compression unit 2002. The compression unit 2002 comprises a raster/block conversion unit 2002-1, a DCT conversion unit 2002-2, a quantization unit 2002-3, a reversible compression unit 2002-4, an entropy encoding unit 2002-5 and a code synthesis unit 2002-6.

This structure is basically the same as the first embodiment, except that the raster/block conversion unit 2002-1 and reversible compression unit 2002-4 convert not only the image signal 2010 but also the discrimination signal 2017.

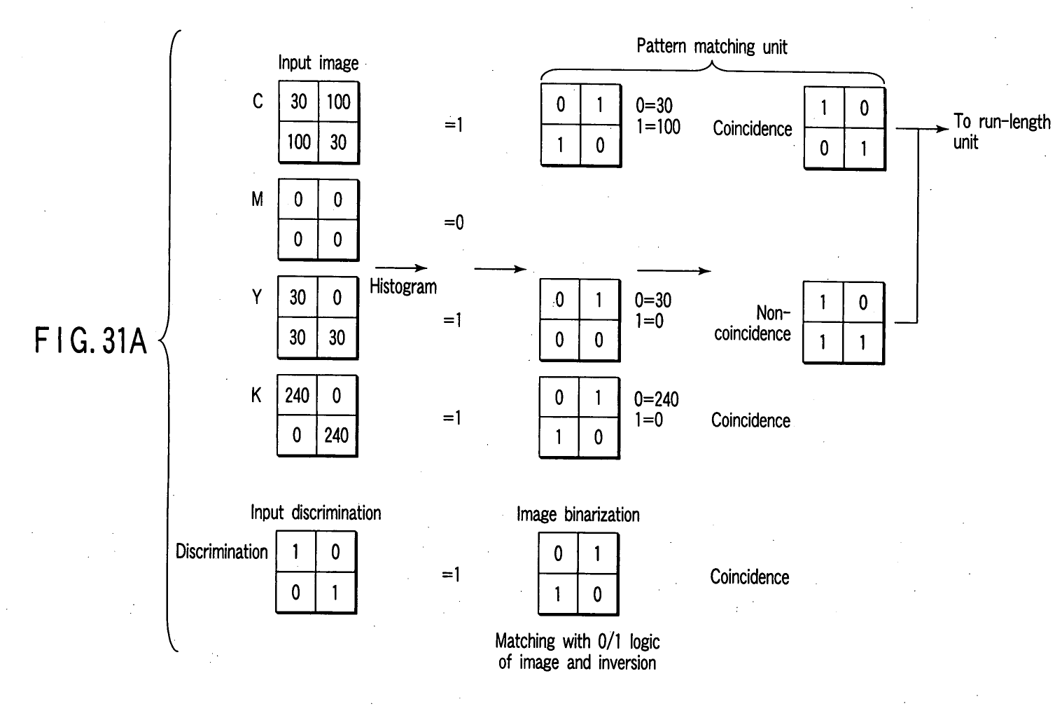

FIG. 30 shows the structure of the reversible compression unit 2002-4. The reversible compression unit 2002-4 comprises a first histogram calculation unit 2002-4-1, a second histogram calculation unit 2002-4-5, a pattern matching unit 2002-4-6, a run-length unit 2002-4-2 and a code length calculation unit 2002-4-3.

This structure is basically the same as in the first embodiment, except that the histogram calculation unit 2002-4-5 calculates a histogram of the discrimination data (signal), the pattern matching unit 2002-4-6 pattern-matches the discrimination data and image data, and the run-length unit 2002-4-2 processes the matched signal.

The pattern matching unit 2002-4-6 converts the image data (signal) to binary data of 0 or 1 when multi-value image data 2002-4-4 and multi-value discrimination data 2002-4-7 indicate that both the discrimination data and image plane have binary data. Thus, the pattern matching unit 2002-4-6 executes pattern matching. If the patterns coincide, the pattern matching unit 2002-4-6 outputs binary value information of the patterns. If the patterns do not coincide, the pattern matching unit 2002-4-6 outputs binary information of both the discrimination and image.

The pattern matching unit 2002-4-6 outputs the discrimination data (signal) if only the discrimination data is binary, and outputs the image data (signal) if only the image data (signal) is binary. Subsequently, the run-length unit 2002-4-2 executes run-length compression.

The code length calculation unit 2002-4-3 adds the kind of the object of run-length processing on the basis of the compression-object data, and outputs the code length and run-length code.

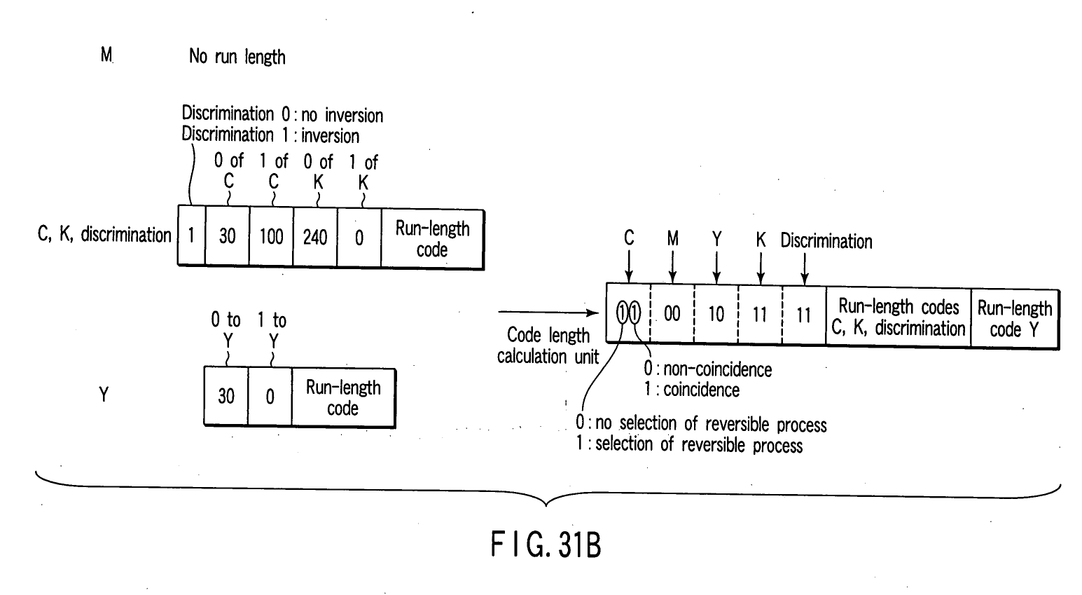

FIG. 31A and FIG. 31B illustrate the operation of the second embodiment, using an example in which 1 block has a 2×2 size, as in the first embodiment.

In FIG. 31A, by the histogram calculations in the first histogram calculation unit 2002-4-1 and second histogram calculation unit 2002-4-5, the C, Y, K and discrimination data are selected as objects of reversible compression. In the present embodiment, as regards the image, the pixel value of the upper left coordinates is treated as 0. The discrimination data is in the binary state from the beginning, and it is not ensured that the upper left pixel is 0. In order to make the logic of the upper left pixel of the discrimination data consistent with the image, 0/1 inversion is executed. This is for the purpose of pattern matching.

Subsequently, the pattern matching unit 2002-4-6 executes pattern matching. As a result of the matching, information indicative of the consistent C, K and discrimination patterns and information indicative of the Y pattern are output to the run-length unit 2002-4-2.

In FIG. 31B, the run-length unit 2002-4-2 encodes coincidence/non-coincidence of the representative value of the binary information of 0 and 1 and the binary run-length result.

The code length calculation unit 2002-4-3 adds information that indicates whether each plane of C, M, Y, K and discrimination data is selected for reversible compression (=1) or not (=0), and whether each plane coincides with the other plane (=1) or not (=0). The code length calculation unit 2002-4-3 calculates the code length along with the run-length code.

In the present embodiment, the discrimination signal, which has less multi-values than the image signal, can be encoded along with the image signal that has similarly less multi-values. Therefore, the handling of the compression data is easy, and the encoding efficiency and image quality can be improved.

Both the discrimination signal and image signal are described on the presupposition of 2-values (binary) signals. It is obvious, however, that the similar process is basically applicable if the signal has several value levels.

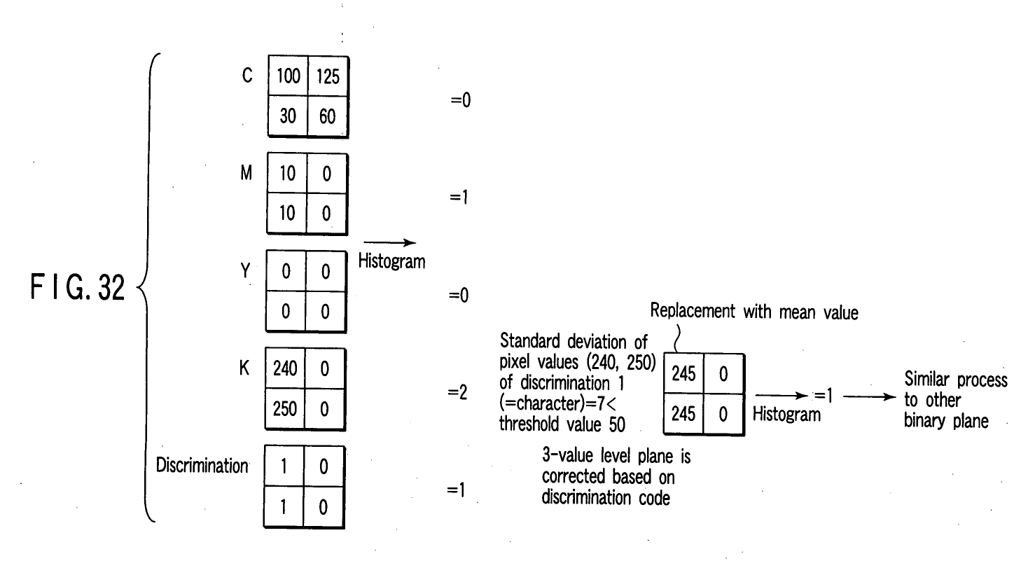

In the present embodiment, the reversible compression unit is described on the presupposition of reversible compression of both the image signal and discrimination signal. On the other hand, a structure as shown in FIG. 32 can be adopted. In the structure in FIG. 32, correction to a binary level signal is executed in accordance with the discrimination signal, and the resultant signal is subjected to run-length reversible compression. That is, in the structure, reversible compression, quasi-reversible compression and irreversible compression are mixedly applied.

In the operation of this case, the histogram calculation unit determines 2-value (=1), 3-value (=2) and non-2/3-value (=0). As regards a 3-value plane, a standard deviation of pixels of the region where the discrimination signal is 1 (character) is found. If the standard deviation is less than a predetermined threshold, the pixel value of the character region is replaced with a mean value of pixel values of the region where the discrimination signal is 1 (in the present embodiment, at the time when the histogram of the discrimination signal is also binary). Histogram determination is executed once again. In the case of 2-value, a process similar to the process for other 2-value planes is executed. In the case of 3-value, the plane is excluded from the objects of reversible objects.

The reason for this is that even if the input signal is a character, the input signal is expressed by several value levels using an anti-alias process, etc. and a scan signal can, in general, be input as a several-value-level signal even if the scan signal is a character. If more importance is placed on the reduction in code amount than on the image quality, the several-value-level signal is not subjected to reversible compression. Instead, the corrected and binarized image is compressed. Thereby, it becomes possible to generate a code that has a higher image quality than in the case of simple irreversible compression and that has a smaller code amount than in the case of reversible compression of 3-value information.

Further, not only an image, for which 3-value information is subjected to binary (2-value) quasi-reversible processing, but also 3-value information itself may be subjected to irreversible compression, as described in the first embodiment. Thus, using both irreversible information and quasi-reversible information, a correction process can be executed.

In the present embodiment, irreversible compression is assigned to the rest of the code amount after reversible encoding. For example, if the discrimination signal is a block indicative of a photo, the irreversible code may first be encoded, and the rest may be assigned to reversible encoding or subjected to no reversible encoding. In this case, a greater amount of information is assigned to the irreversible code, and the image quality is enhanced when the irreversible code is taken out by the third code conversion unit 2009.

In the embodiments including the first embodiment, the color image has been exemplified. In the above description, the 3-value signal is binarized, and reversible and irreversible processings are separately executed on a plane-by-plane basis such that binary data is subjected to reversible processing and 3-value data is subjected to irreversible processing. Instead, with respect the same plane, information that is to be treated as reversible and information that is to be treated as irreversible may be processed. Thereby, even for a monochromatic image signal that comprises only 1 plane, a plurality of compression schemes may similarly be used in a mixed manner.

As has been described above, according to the embodiments of the present invention, a plurality of encoding schemes can be selected at the same time for the same region of the image. Thereby, the convenience in use of codes and the image quality can be improved.

In the embodiments, the run-length scheme is used for reversible processing, and the DCT scheme is used for irreversible processing. The invention, however, is not restricted to specific combinations of reversible and irreversible processes and run-length scheme and DCT scheme. Although the discrimination signal is treated as reversible, the scheme for the discrimination signal is not limited and may be altered depending on uses.

The present invention has the following structures.

There is provided an image compression apparatus comprising: a block division unit that executes block division of an M-value image; an image conversion unit that reduces the divided image to N-value (N<M) data per pixel; a first compression unit that compresses the image data from the image conversion unit to first compression data; a second compression unit that compresses the divided M-value image to second compression data on the basis of an amount of the first compression data and a predetermined data amount per block; and a code conversion unit that executes conversion to third compression data that is formed of the first compression data and the second compression data and has a predetermined code amount per block.

There is provided an image compression apparatus comprising: a determination unit that determines an attribute of an M-value image; a block division unit that executes block division of the M-value image and attribute information; an image conversion unit that reduces the divided image to N-value (N<M) data per pixel; a first compression unit that compresses the image data and block-divided attribute information from the image conversion unit to first compression data; a second compression unit that compresses the divided M-value image to second compression data on the basis of an amount of the first compression data and a predetermined data amount per block; and a code conversion unit that executes conversion to third compression data that is formed of the first compression data and the second compression data and has a predetermined code amount per block.

There is provided an image compression apparatus comprising: a block division unit that executes block division of an M-value image and image attribute information that is different from an image signal; an image conversion unit that reduces the divided image to N-value (N<M) data per pixel in accordance with the image attribute information; a first compression unit that compresses the image data and block-divided attribute information from the image conversion unit to first compression data; a second compression unit that compresses the divided M-value image to second compression data on the basis of an amount of the first compression data and a predetermined data amount per block; and a code conversion unit that executes conversion to third compression data that is formed of the first compression data and the second compression data and has a predetermined code amount per block.

There is provided an image compression apparatus comprising: a block division unit that executes block division of an image that is composed of a plurality of signals; a determination unit that determines an attribute of the image; a first compression unit that compresses an arbitrary signal of the divided image to first compression data; a second compression unit that compresses the arbitrary signal of the divided image to second compression data; and a code conversion unit that executes conversion to third compression data that is formed of the first compression data and the second compression data and has a predetermined code amount per block, wherein the first compression unit executes reversible encoding, the second compression unit executes irreversible encoding, switching is executed, on the basis of the attribute, to give a preference to one of the first and second compression data amounts in order to execute conversion to a predetermined data amount, and each of the plurality of signals is included in at least one of the first and second compression data.

There is provided an image decoding apparatus that decodes first compression data, which includes information that indicates white and non-white, and second compression data in which an image is compressed, wherein as regards a decoded image of the second compression data, a pixel that is indicated as being a white pixel by decoding the first compression data is corrected to the white pixel.

There is provided an image processing apparatus that handles codes, in which codes that are produced by encoding an image by a plurality of encoding schemes in units of a block are mixedly present and at least one of the encoding schemes is selected for each block, wherein one of the encoding schemes is an encoding scheme that is directed to 2-value to several-value data, and OCR is executed on codes that are directed to the 2-value to several-value data.

There is provided an image decoding apparatus that decodes compression data, which is at least one of first and second compression data in which an image is compressed, wherein a decoding unit that decodes the first compression data comprises a programmable circuit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image compression apparatus comprising:
a block division unit that executes block division of an image;
a first compression unit that compresses the image, which is divided by the block division unit, to first compression data;
a second compression unit that compresses the image, which is divided by the block division unit, to second compression data on the basis of an amount of the first compression data and a predetermined data amount per block; and
a code conversion unit that executes conversion to third compression data that is formed of the first compression data and the second compression data and has a predetermined code amount per block.

2. The image compression apparatus according to claim 1, wherein the first compression unit compresses the image when the image in the block meets a predetermined condition.

3. The image compression apparatus according to claim 1, wherein the first compression unit comprises a programmable circuit.

4. An image compression apparatus comprising:
a block division unit that executes block division of an image that is composed of a plurality of signals;
a first compression unit that compresses an arbitrary signal of the image, which is divided by the block division unit, to first compression data;
a second compression unit that compresses the image, which is divided by the block division unit, to second compression data on the basis of an amount of the first compression data and a predetermined data amount per block; and
a code conversion unit that executes conversion to third compression data that is formed of the first compression data and the second compression data and has a predetermined code amount per block.

5. The image compression apparatus according to claim 4, wherein each of the plurality of signals is included in at least one of the first and second compression data.

6. The image compression apparatus according to claim 4, wherein each of the plurality of signals is included in at least one of the first and second compression data, the first compression unit executes reversible encoding, and the second compression unit executes irreversible encoding.

7. The image compression apparatus according to claim 4, wherein each of the plurality of signals is included in at least one of the first and second compression data, the first compression unit executes reversible encoding with a predetermined code amount or less, and the second compression unit executes irreversible encoding.

8. The image compression apparatus according to claim 4, wherein each of the plurality of signals is included in at least one of the first and second compression data, the first compression unit executes compression suitable for an image signal with a plurality of gray levels, and the second compression unit executes compression suitable for a multi-value.

9. The image compression apparatus according to claim 4, wherein each of the plurality of signals is included in at least one of the first and second compression data, the first compression unit executes compression suitable for an image signal with a plurality of gray levels, the second compression unit executes compression suitable for a multi-value, the first compression unit executes run-length coding or pattern embedding, and the second compression unit executes orthogonal transform.

10. The image compression apparatus according to claim 4, wherein each of the plurality of signals is included in at least one of the first and second compression data, and the signal is included in both the first and second compression data in a case where the signal is composed of only a DC component in units of a block.

11. The image compression apparatus according to claim 4, wherein each of the plurality of signals is included in at least one of the first and second compression data, and the second compression data is compressed with respect to only a DC component of the signal in a case where the signal is included in the first compression data.

12. The image compression apparatus according to claim 4, wherein each of the plurality of signals is included in at least one of the first and second compression data, and the second compression data is compressed such that only a DC component of a code comprising the DC component and an AC component is made into a compression code, in a case where the signal is included in the first compression data.

13. The image compression apparatus according to claim 4, wherein each of the plurality of signals is included in at least one of the first and second compression data, and the second compression unit transforms a block value of the signal to only a DC component and then executes compression to the second compression data, in a case where the signal is included in the first compression data.

14. An image compression apparatus including a block division unit that executes block division of an image, a first compression unit that compresses information, which discriminates between a first predetermined pixel value and another pixel value with respect to the divided image, to first compression data, and a second compression unit that compresses the divided image to second compression data,
wherein when the information, which discriminates between the predetermined pixel value and said another pixel value, is compressed with respect to the block, the second compression unit executes image compression by replacing at least one of the first predetermined pixel value and said another pixel value of the block with a first predetermined value or a second predetermined value.

15. An image compression apparatus comprising:
a first compression unit that compresses information, which indicates white and non-white with respect to an image, to first compression data; and
a second compression unit that compresses the image to second compression data.

16. An image compression apparatus including a block division unit that executes block division of an image, a first compression unit that compresses information, which indicates white and non-white with respect to the divided image, to first compression data, and a second compression unit that compresses the divided image to second compression data,
wherein when the information, which indicates white and non-white, is compressed with respect to the block in the first compression unit, the second compression unit executes image compression by replacing a white pixel of the block with a pixel other than the white pixel.

17. The image compression apparatus according to claim 16, wherein when the information, which indicates white and non-white, is compressed with respect to the block in the first compression unit, the second compression unit executes image compression by replacing a white pixel of the block with a mean value of non-white pixels in the block.

18. An image compression apparatus comprising:
a block division unit that executes block division of an image and image attribute information that is different from an image signal;
a first compression unit that compresses the image and the image attribute information, which are divided by the block division unit, to first compression data;
a second compression unit that compresses the image, which is divided by the block division unit, to second compression data on the basis of an amount of the first compression data and a predetermined data amount per block; and
a code conversion unit that executes conversion to third compression data that is formed of the first compression data and the second compression data and has a predetermined code amount per block.

19. The image compression apparatus according to claim 18, wherein the first compression unit equally treats and compresses the image information and the image attribute information.

20. The image compression apparatus according to claim 18, wherein switching is executed, on the basis of the attribute, to give a preference to one of the first and second compression data amounts in order to execute conversion to a predetermined data amount.

21. An image decoding apparatus that decodes compression data, in which an image that is composed of a plurality of signals is compressed as first and second compression data and at least an arbitrary one of the plurality of signals is compressed in one of the first and second compression data,
wherein a decoded result of one of the first and second compression data is adopted for a signal that is included in both the first compression data and the second compression data.

22. The image decoding apparatus according to claim 21, wherein the first compression data is reversible compression data, the second compression data is irreversible compression data, and a decoded result of the first compression data is adopted for the signal that is included in both the first compression data and the second compression data

23. An image decoding apparatus that decodes first compression data, which includes information that discriminates between a predetermined pixel value and another pixel value, and second compression data in which an image is compressed,
wherein as regards a decoded image of the second compression data, a pixel that is indicated as having the predetermined pixel value by decoding the first compression data is corrected to the predetermined pixel value.

24. An image converting apparatus that handles codes, in which codes that are produced by encoding an image by a plurality of encoding schemes in units of a block are mixedly present and at least one of the encoding schemes is selected for each block,
wherein a code, which is produced by a specified encoding scheme, is taken out of the codes, and the code that is produced by the specified encoding scheme is output as a substitute when there is no code corresponding to the block.

25. An image processing method that executes such a process that as regards compression data that is produced by fixed-length compressing a block-divided image by at least one of first and second compression schemes, significant information in each compression unit of arbitrary compression data is replaced with other compression data that is compressed by at least one of the first and second compression schemes.
